(19) United States
(12) Patent Application Publication
(10) Pub. No.: US 2020/0034768 A1
(43) Pub. Date: Jan. 30, 2020

(54) ENERGY CONSERVATION DIAGNOSTIC SYSTEM, METHOD AND PROGRAM

(71) Applicant: Bizen Green Energy Corporation, Bizen-shi, Okayama (JP)

(72) Inventor: Takuo Yamaguchi, Bizen-shi, Okayama (JP)

(21) Appl. No.: 16/491,676

(22) PCT Filed: Mar. 8, 2018
(86) PCT No.: PCT/JP2018/010356

§ 371 Date: Sep. 6, 2019

(30) Foreign Application Priority Data
Mar. 10, 2017 (JP) 2017-066203

(51) Int. Cl. G06Q 10/06; G06Q 10/04; G06F 1/3206; H02J 3/00; G01W 1/06

(52) U.S. Cl. CPC G06Q 10/06315; G06Q 10/04; G06Q 50/06; H02J 3/00; G01W 1/06; G06F 1/3206

(57) ABSTRACT

Diagnosing energy conservation requires not only various measurement items and a vast amount of data but also advice from experts having knowledge of energy conservation diagnosis, and there has been no such method for diagnosing energy conservation easily. Provided therefore is a system that makes it possible to achieve energy conservation diagnosis with high accuracy without requiring expert knowledge by using the energy consumption data of the building and the weather data of the meteorological station closest to the location of the building to estimate each-usage energy consumption of the building and to calculate energy savable amount, demand reducible amount, and an energy saving effect achieved by the behavior change and the like, and systematizing the calculation by using a statistical method and the like.

### TECHNICAL FIELD

The present disclosure relates to a system, a method, and programs for calculating energy consumption of each usage in a building and an energy savable amount thereof based on an energy consumption of the building easily with high accuracy.

### BACKGROUND

As global warming is accelerating these days, the necessity of energy conservation (hereinafter, also referred to as energy saving) is being advocated worldwide in order to reduce emission of greenhouse gases such as carbon dioxide and the like. As a part thereof, energy conservation diagnosis of buildings (diagnosis for saving energy) has become active. Through performing energy conservation diagnosis on the building that requires energy saving, measures for saving energy in the building can be specified, thereby enabling proper energy saving. That is, it is not only necessary to perform energy conservation diagnosis but also necessary to execute the diagnosis content with high accuracy, so that it is desired to develop a simple and highly accurate energy conservation diagnostic method. Further, it is also desired to develop a method for extracting a building with a high energy saving effect from a large number of buildings in order to support highly efficient energy saving measures. It is required to be able to perform extraction thereof by using information that can be acquired by electric power companies, gas companies, and the like.

As one of diagnostic methods, for example, there is proposed Patent Literature 1 which performs determination processing based on operation state information of selected energy-saving target equipment and reference information (selection reference information). Specifically, in a case of air-conditioning equipment including a chiller, for example, cooling capacity, power consumption, load factor, operating period, operating time, working time, pump flow amount, fan air-flow amount, periodic maintenance state, and the like are inputted, scale of the air-conditioner is estimated, the cooling power (peak) and the cooling power amount (volume) are roughly evaluated, whether or not the air-conditioning is stopped at night and whether or not it is a cooler in midseason and winter are determined, whether or not pre-cooling time exceeds 30 minutes, whether or not stop time exceeds working end time, and whether or not a valve throttle and a damper throttle are adjusted properly are determined.

Further, Patent Literature 2, for example, proposes an energy conservation diagnostic system using a mobile terminal for enabling energy conservation diagnosis of a building without having an expert such as a qualified person for energy management with expert knowledge and experience for energy conservation visit the actual place. Specifically, regarding a building as a subject of diagnosis, individual building data that specifies equipment of which the data to be collected, data items to be collected of each piece of equipment, and determination criteria of energy conservation diagnosis performed based on the collected data are set, and configuration for outputting the determination criteria of energy conservation diagnosis and executable energy saving measures are set and equipped by an expert of energy saving for allowing the diagnosis to be performed at the actual place of collecting the data not necessarily having the expert knowledge of energy saving.

As still another diagnostic method, proposed is a method as in Patent Literature 3 which estimates air-conditioning load of a subject building from an actual energy use of an existing building, for example. Specifically, regarding an existing building, actually measured values of the whole air-conditioning load of the air-conditioning equipment of a certain short period and power consumed for air-conditioning are compared, converted values of the air-conditioning load with respect to the power consumption are calculated, and the air-conditioning load of a certain building of each hour of a year is estimated based on the data of energy consumption of the power and the like. At the time of this calculation, more accurate calculation becomes possible by taking seasonal fluctuation factors and the like other than non-business day and air-conditioning into consideration. This method can also be applied for designing energy saving of a similar building to be constructed anew in addition to estimation of data using actually measured data.

### CITATION LIST

### Patent Literature

Patent Literature 1: Japanese Patent Application Laid-Open No. 2012-59122

Patent Literature 2: Japanese Patent Application Laid-Open No. 2012-226432

Patent Literature 3: Japanese Patent Application Laid-Open No. 2008-298375

### SUMMARY

### Problems to be Solved by the Invention

However, there are following problems with the conventional techniques described above.

Patent Literature 1 is not a simple method because it is necessary to introduce a large number of measurement devices in order to increase accuracy of diagnosis so that the introduction cost is high and it is necessary to input various kinds of data.

With Patent Literature 2, it is necessary to set an appropriate energy-saving target value of each building as a subject, and knowledge of experts is still required for enabling calculation such that the energy-saving target value becomes an appropriate value.

Further, with Patent Literature 3, diagnosis results are not necessarily considered appropriate because estimation is performed by acquiring actually energy consumption from an existing building and the diagnosis is performed on the assumption that there is a lot of waste in the building consuming a great amount of energy.

Further, with the techniques disclosed in Patent Literatures 1 and 3, determination of use days and non-use days (or holidays) are determined relying only on input from outside, and determination is made by taking a week where the energy consumption is the least in a year as an energy base period, for example. Therefore, it is hard to be considered as statistical processing.

Further, with the techniques disclosed in Patent Literatures 1, 2, and 3, it is not practically possible to extract a building with high energy saving effect from a plurality of buildings because the energy saving effect cannot be calculated only with the energy consumption data and building location information which can be acquired by the electric power company, the gas company, and the like.

In view of the aforementioned problems, the present disclosure provides a system capable of performing appropriate energy conservation diagnosis through using the method of the present disclosure based on statistical ideas by using easily acquirable information to enable energy conservation diagnosis of buildings and extraction of buildings with a high energy saving effect, and proposes the diagnostic method thereof.

### Solution to Problem

The present disclosure performs estimation of energy consumptions of each usage of the building and calculation of an energy savable amount, a demand reducible amount, and the energy saving effect by behavior change, and the like by using the energy consumption data of the building and weather data of a meteorological station closest to the location of the building by using the method of the present disclosure based on the statistical ideas so as to enable energy conservation diagnosis with high accuracy and to enable extraction of a building with a high energy saving effect from a plurality of buildings only with the information which can be acquired by the electric power company, the gas company, and the like.

Hereinafter, means of the present disclosure will be described. Before that, definitions of terms will be described by referring to FIG. 26.

“Data” denotes a chunk of same kind of values and, for example, energy consumption data is a chunk of energy consumption measured at each measurement date/time.

“Index” is a title when forming a set of values, and “measurement date/time” is an index, for example.

“Data list” is a set of values grouped with an index. For example, in a case where “measurement date/time” is the index, the measurement date/time, the energy consumption at the measurement date/time, weather amount, and the like are a data list.

“Data table” is a set of data lists, and “database” is a set of data tables.

Subsequently, the energy consumption data, the building location, and the weather data used in the present disclosure as well as the energy consumption of each usage estimated by the present disclosure will be described.

The energy consumption data is electric power consumption and a gas consumption of a building measured at a measurement interval of one hour or less. As an example, values measured by a smart meter may be considered.

“Data measurement period” is basically one year, but it is possible to perform analysis with data of six months or more.

“Building location” is an address of a place where a building is located.

“Weather data” denotes enthalpy and the like calculated from temperatures or from temperatures and humidity.

“Operating day” denotes a day when a building is operating. The operating day is a workday in a typical office, while it is a business day in a typical business facility. “Non-operating day” denotes a day when the building is not operating, and it is typically a holiday. “Holiday-work date” denotes a non-operating day where some of the workers come to work.

“Estimation of energy consumption of each usage” denotes estimation of usage of “ac”, “middle”, and “base”. Note that “ac” denotes mainly air-conditioning energy consumption, “middle” denotes the energy consumption of the building such as lighting and office automation equipment used in an operating time zone, and “base” denotes energy consumption of apparatuses used for 24 hours, such as guiding light.

Subsequently, a method used for a plurality of times in description of preferred embodiments of the present disclosure will be described.

“Standardization” is conversion achieved by subtracting an average value of a value group (data) to be a subject from a subject value, and dividing the difference thereof by standard deviation calculated from each of the subject values.

As regression methods, not only regression of typical linear model but also various kinds of regression methods such as ridge regression and lasso regression are included.

As an example of abnormal value detection method, as expressed in expressions 1 and 2, there is a method which: acquires a probability distribution function along an abnormality distribution by using estimate value (f(x⁽ⁿ⁾) acquired by substituting an independent variable (x⁽ⁿ⁾) to a regression equation and abnormality (α(y⁽ⁿ⁾, x⁽ⁿ⁾) derived from an actual measurement value (x⁽ⁿ⁾; sets a threshold value with which cumulative probability density of the probability distribution function takes a value of a specific value or more; determines the measurement value derived as abnormal being larger than the threshold value as abnormal value; and sets an abnormal flag on a corresponding data list to discriminate it from other data lists. Note here that “N” denotes the number of pieces of data, and “n” denotes that it is the n-th data.

$$\begin{matrix}σ = \frac{1}{N} {\sum }_{n = 1}^{N} {( {y}^{( n )} - f ( {x}^{( n )} ) )}^{2} & [ Expression 1 ] \\ α ( {y}^{( n )} , {x}^{( n )} ) = \frac{1}{σ} {( {y}^{( n )} - f ( {x}^{( n )} ) )}^{2} & [ Expression 2 ]\end{matrix}$$

For the probability distribution function, a gamma distribution function, a chi-square distribution function, or the like is used.

Further, the larger value out of two independent variables for calculating the abnormal value that is same as the threshold value at the time of detection of the abnormal value is calculated as a statistically upper limit value, and the smaller value as a statistically lower limit value.

An energy conservation diagnostic system will be described by referring to FIG. 1. The energy conservation diagnostic system is configured with: a database that collects energy consumption data and weather data via a network; an each-usage energy consumption estimation program for calculating the energy consumption of each usage by using the energy consumption data and the weather data recorded on the database; and an energy saving simulation program for calculating an energy saving effect achieved by behavior change and the like; and an output unit that outputs a calculation result.

The database collects and records the energy consumption data and the measurement content of the meteorological station and further records calculation results of the each-usage energy consumption estimation program, the energy savable amount calculation program, and the energy saving simulation program.

The each-usage energy consumption estimation program enables estimation of the energy consumption of each usage in the existing building by using the energy consumption data and the weather data of the meteorological station closest to the location of the building. The each-usage energy consumption is the consumption of “ac”, “middle”, and “base” of every specific time. Every specific time herein is any setting such as 10-minute interval, 15-minute interval, 20-minute interval, 30-minute interval, and one-hour interval.

FIG. 2 is a flowchart illustrating an outline of the each-usage energy consumption estimation program. The each-usage energy consumption estimation program is configured with seven units that are a data generation unit (S102), an operating day/non-operating day determination unit (S103), a holiday-work determination unit (S104), a regression equation calculation unit (S105), a baseline estimation unit (S106), a baseline correction unit (S107), an each-usage energy consumption estimation unit (S108).

The data generation unit re-totalizes the energy consumption data and the weather data recorded on the database by every specific time, and generates a data table classified by measurement date/time having the measurement date/time as the index. Further, the data table classified by each measurement date/time is counted by each measurement day to generate a data table classified by each measurement day.

The operating day/non-operating day determination unit determines the operating day and the non-operating day. A primary regression equation for each day is generated by using the energy consumption data and the weather data of the data table classified by each day, and calculates a primary regression determination coefficient for each day. An abnormal value of the energy consumption data is detected by using an estimate value derived from the primary regression equation for each day, and a primary abnormal flag of each day is set on the energy consumption of the abnormal value. When the primary regression determination coefficient for each day is smaller than a set threshold value, the measurement days are classified into the operating day and non-operating day. When the primary regression determination coefficient for each day is equal to or larger than the set threshold value, all the measurement days are classified into the operating day.

For classifying the measurement days into the operating days and the non-operating days, initial distribution of the operating days and non-operating days is performed.

While there are various methods of initial distribution, used in this case is a method which distributes the measurement day of the largest energy consumption in each month as the operating day and the measurement day of the minimum value as the non-operating day.

By having initially distributed days as training data, the remaining measurement days are classified into the operating days and non-operating days by using a clustering method from a scatter plot having the weather data as the independent variable and the energy consumption data as a dependent variable.

Regression having the weather data as the independent variable and the energy consumption data as the dependent variable is performed separately for the operating days and the non-operating days to calculate operating day regression equation for each day, operating day regression determination coefficient for each day, non-operating day regression equation for each day, and non-operating day regression determination coefficient for each day. When the operating day regression determination coefficient for each day is smaller than the set threshold value, a flag is set indicating that there is no air-conditioning in the building. Abnormal values of the energy consumption of each day are detected by using the operating day regression equation for each day and the non-operating day regression equation for each day separately for the operating days and non-operating days, a secondary abnormal flag of each day is set on the energy consumption of the abnormal values, and the statistically upper limit value and lower limit value are calculated.

The holiday-work determination unit determines the holiday-work date on the data list of the secondary abnormal flag of each day. In a case of the operating day, when the energy consumption is smaller than the estimate value of the secondary operating day regression equation for each day, a holiday-work date flag is set and the operating day is changed to the non-operating day. In a case of the non-operating day, when the energy consumption is larger than the estimate value of the secondary operating day regression equation for each day, the holiday-work date flag is set. After recording those calculation results to the data table classified by measurement date/time, the data table classified by the days and the data table classified by each measurement date/time are integrated by having the measurement days as the key to generate an analysis table classified by each measurement date/time.

The regression equation calculation unit combines the operating days, non-operating days, and the measurement time, put the analysis data table classified by each measurement date/time into groups by each measurement time of the operating days and each measurement time of the non-operating days (hereinafter, also referred to as each group classified by operating days, non-operating days, and measurement time), performs regression by taking the weather data of each measurement time as the independent variable and measurement time and having the energy consumption data of each measurement date/time as the dependent variable of each group classified by the operating days, non-operating days, and measurement time, and calculates the regression equation and the time regression determination coefficient. The minimum value of the estimate values within a range of the weather data of each group classified by operating days, non-operating days, and measurement time is calculated by using the regression equation for each group classified by operating days, non-operating days, and measurement time. By taking the minimum value of the estimate values of the weather data of each group classified by operating days, non-operating days, and measurement time as the regression baseline, the value of the weather data deriving the minimum estimate value is taken as the minimum weather amount. Excluding the secondary abnormality data list classified by each day, an average value (time average value) and standard deviation of the energy consumption data of each measurement date/time are calculated of each group classified by operating days, non-operating days, and measurement time, and the average value is taken as an average baseline.

The baseline estimation unit calculates the energy consumption estimate value and the baseline based on the results acquired by the regression equation calculation unit.

The operating day time regression estimate values are calculated from the operating day regression equation for each measurement time. The distribution function of variance is acquired from the operating day time regression estimate value data and energy consumption data filed by the operating days, variance of all the operating day time regression estimate values and energy consumption data are applied to the distribution function to detect an abnormal value, and an operating day time regression abnormal flag is set. Further, an operating day time regression upper limit value is calculated as the statistical upper limit value, and an operating day time regression lower limit value is calculated as the statistical lower limit value. Same calculations are performed for the non-operating days to calculate non-operating day time regression estimate values, a non-operating day time regression abnormal flag, a non-operating day time regression upper limit value, and a non-operating day time regression lower limit value. Further, the abnormal value of the energy consumption is detected from the operating day time average value and the standard deviation, and an operating day time average abnormal flag is set. Further, an operating day time average upper limit value is calculated as the statistical upper limit value, and an operating day time average lower limit value is calculated as the statistical lower limit value. Same calculations are performed for the non-operating days to calculate a non-operating day time average value, a non-operating day time average abnormal flag, a non-operating day time average upper limit value, and a non-operating day time average lower limit value. An estimate data table classified by each measurement date/time is generated, and the calculation results are recorded thereon.

It is determined whether the regression baseline or the average baseline is taken as the baseline of each group classified by the operating days, non-operating days, and measurement time. When there is a flag indicating no air-conditioning or when the time regression determination coefficient is equal to or lower than the set threshold value, the average baseline is inputted for the baseline. In other cases, the regression baseline is inputted for the baseline. When the regression baseline is selected, correlation between the energy consumption data of each measurement date/time and the weather data is calculated within a range where the weather data of each measurement date/time is larger than the minimum weather amount. When the correlation is recognized as statistically significant and also a correlation coefficient is a positive value, a cooler flag is set. Correlation between the energy consumption data of each measurement date/time and weather data of each measurement date/time is calculated within a range where the weather data of each measurement date/time is equal to or smaller than the minimum weather amount. When the correlation is recognized as statistically significant and also a correlation coefficient is a negative value, a heater flag is set. Those are recorded on a baseline data table.

The estimate data table of each measurement date/time and the baseline data table are integrated using each group classified by the operating days, non-operating days, and measurement time as a key. Further, the data table integrated with the analysis data table classified by each measurement date/time is integrated by using the measurement date/time as a key to generate an integrated data table classified by each measurement date/time.

The baseline correction unit mainly corrects the baselines of the building having no air-conditioning, in time zones where air-cooling or air-heating is not performed, and on the holiday-work date.

First, it is prepared for performing correction of the baseline.

When the time regression determination coefficient is larger than the set threshold value in a case of the operating day, the operating day time regression estimate value is inputted to the time estimate value, the operating day time regression abnormal flag is inputted to the time abnormal flag, the operating day time regression upper limit value is inputted to the time upper limit value, and the operating day time regression lower limit value is inputted to the time lower limit value. In a case of the non-operating day, the non-operating day time regression estimate value is inputted to the time estimate value, the operating day time regression abnormal flag is inputted to the time abnormal flag, the non-operating day time regression upper limit value is inputted to the time upper limit value, and the non-operating day time regression lower limit value is inputted to the time lower limit value.

When the time regression determination coefficient is equal to or smaller than the set threshold value in a case of the operating day, the operating day time average estimate value is inputted to the time estimate value, the operating day time average abnormal flag is inputted to the time abnormal flag, the operating day time average upper limit value is inputted to the time upper limit value, and the operating day time average lower limit value is inputted to the time lower limit value. In a case of the non-operating day, the non-operating day time average value is inputted to the time estimate value, the operating day time average abnormal flag is inputted to the time abnormal flag, the non-operating day time average upper limit value is inputted to the time upper limit value, and the non-operating day time average lower limit value is inputted to the time lower limit value.

The minimum value of the baseline excluding the data list of each measurement date/time is taken as a “base” standard value.

Subsequently, following processing is performed for each measurement date/time to correct the baseline.

When the energy consumption of each measurement date/time is smaller than the baseline or there is a flag indicating no air-conditioning, the energy consumption of each measurement date/time is inputted to the baseline, and processing of the next measurement date/time is performed.

When there is no flag indicating having a cooler in a case where the energy consumption of each measurement date/time is equal to or larger than the baseline, there is no flag indicating no cooler, and the weather amount of each measurement date/time is larger than the minimum weather amount, the energy consumption of each measurement date/time is inputted to the baseline.

When there is no flag indicating having a heater in a case where the energy consumption of each measurement date/time is equal to or larger than the baseline, there is no flag indicating no air-conditioning, and the weather amount of each measurement date/time is equal to or smaller than the minimum weather amount, the energy consumption of each measurement date/time is inputted to the baseline.

When there is no holiday-work date flag and no abnormal flag, processing of the next measurement date/time is performed.

When there is the holiday-work date flag or the abnormal flag, it is the non-operating day, and the energy consumption of each measurement date/time is equal to or less than the non-operating day time estimate value, processing of the next measurement date/time is performed.

When there is the holiday-work date flag or the abnormal flag, it is the non-operating day, the energy consumption of each measurement date/time is larger than the non-operating day time estimate value, and the energy consumption of each measurement date/time is larger than the operating day time estimate value, the operating day estimate value is inputted to the time estimate value, the operating day time upper limit value is inputted to the time upper limit value, and the operating day time lower limit value is inputted to the time lower limit value.

When there is the holiday-work date flag or the abnormal flag, it is the non-operating day, the energy consumption of each measurement date/time is larger than the non-operating day time estimate value, and the energy consumption of each measurement date/time is equal to or less than the operating day time estimate value, values calculated by expression A are inputted.

Expression A includes following formulae 3 to 6.

Baseline=operating day baseline×energy consumption of each measurement date/time/operating day time estimate value [Expression 3]

Time estimate value=energy consumption of each measurement date/time [Expression 4]

Time upper limit value=operating day time upper limit value×energy consumption of each measurement date/time/operating day time estimate value [Expression 5]

Time lower limit value=operating day time lower limit value×energy consumption of each measurement date/time/operating day time estimate value [Expression 6]

When there is the holiday-work date flag or the abnormal flag, it is not the non-operating day, and the energy consumption of each measurement date/time is equal to or larger than the operating day time estimate value, processing of the next measurement date/time is performed.

When there is the holiday-work date flag or the abnormal flag, it is not the non-operating day, the energy consumption of each measurement date/time is smaller than the operating day time estimate value, and the energy consumption of each measurement date/time is smaller than the non-operating day time estimate value, the non-operating day estimate value is inputted to the time estimate value, the non-operating day time upper limit value is inputted to the time upper limit value, and the non-operating day time lower limit value is inputted to the time lower limit value.

When there is the holiday-work date flag or the abnormal flag, it is not the non-operating day, the energy consumption of each measurement date/time is smaller than the operating day time estimate value, and the energy consumption of each measurement date/time is equal to or larger than the non-operating day time estimate value, values calculated by expression A are inputted. Thereafter, processing of the next measurement date/time is performed.

The specific-application energy consumption estimation unit calculates “ac”, “middle”, and “base” estimate values. When the baseline is larger than the base reference value, “base” is taken as the base reference value. When the baseline is equal to or less than the base reference value, “base” is taken as the baseline.

Note that “ac” is defined as “energy consumption of each measurement date/time−baseline.”

Further, “middle” is defined as the value of “energy consumption of each measurement date/time−ac−base”, that is, the value acquired by subtracting “ac” and “base” from the energy consumption of each measurement date/time, and the calculated values are recorded on the integrated data table classified by each measurement date/time.

With the each-usage energy consumption program described above, consumption of “ac”, “middle”, and “base” is estimated, and calculation results thereof are recorded on the integrated data table classified by each measurement date/time.

The energy savable amount calculation program enables calculation of the energy savable amount and the demand reducible amount by using the calculation results of the each-usage energy consumption estimation program.

The energy savable amount calculation program is configured with an energy savable amount calculation unit and a demand reducible amount calculation unit. The energy savable amount calculation unit calculates the energy savable amount by using the integrated data table of each measurement date/time.

When the energy consumption of each measurement date/time is larger than the time upper limit value, the energy savable amount (step 1) is defined as “energy consumption of each measurement date/time−the time upper limit value”, while defining the energy savable amount (step 1) as 0 (zero) in other cases.

When the energy consumption of each measurement date/time is larger than the time estimate value, the energy savable amount (step 2) is defined as “energy consumption of each measurement date/time−the time estimate value”, while defining the energy savable amount (step 2) as 0 (zero) in other cases.

When the energy consumption of each measurement date/time is larger than the time lower limit value, the energy savable amount (step 3) is defined as “energy consumption of each measurement date/time−the time lower limit value”, while defining the energy savable amount (step 3) as 0 (zero) in other cases.

The energy savable amount of the building is calculated in the manner described above, and an energy savable rate of the building is calculated through dividing the total of the energy savable amount by the total of the energy consumption.

The demand reducible amount calculation unit calculates the demand reducible amount by using the integrated data table of each measurement date/time.

The energy consumption of each measurement date/time, the time upper limit value, the time estimate value, and the time lower limit value are re-totalized by every 30 minutes, and the maximum values are calculated.

When the energy consumption maximum value of every 30 minutes is larger than the upper limit maximum value of every 30 minutes, the demand reduction amount (step 1) is defined as “(energy consumption maximum value of every 30 minutes−upper limit maximum value of every 30 minutes)×2”, and defined as 0 (zero) in other cases.

When the energy consumption maximum value of every 30 minutes is larger than the estimate maximum value of every 30 minutes, the demand reduction amount (step 2) is defined as “(energy consumption maximum value of every 30 minutes−estimate maximum value of every 30 minutes)×2”, and defined as 0 (zero) in other cases.

When the energy consumption maximum value of every 30 minutes is larger than the lower limit maximum value of every 30 minutes, the demand reduction amount (step 3) is defined as “(energy consumption maximum value of every 30 minutes−lower limit maximum value of every 30 minutes)×2”, and defined as 0 (zero) in other cases.

The demand reduction amount (step 1), the demand reduction amount (step 2), and the demand reduction amount (step 3) are recorded on a whole data table.

In the manner described above, the demand reducible amount is calculated.

The energy saving simulation program uses the integrated database classified by measurement date/time to calculate the energy saving effect achieved by the behavior change when the air-conditioning set temperature is changed by 1° C. and 2° C.

Respective estimate values are calculated by generating +1° C. data increased by 1° C. in the ambient temperature from the weather data of each measurement time, +2° C. data increased by 2° C. in the ambient temperature, −1° C. data decreased by 1° C. in the ambient temperature, and −2° C. data decreased by 2° C. in the ambient temperature, and substituting those to the regression equation for each group classified by the operating days, non-operating days, and measurement time.

When the weather amount of each measurement date/time is larger than the minimum weather amount and there is the flag indicating having a cooler, −1° C. estimate value is inputted to 1° C. estimate value, and −2° C. estimate value is inputted to 2° C. estimate value.

When the weather amount of each measurement date/time is larger than the minimum weather amount and there is no flag indicating having a cooler, the time estimate value is inputted to the 1° C. estimate value and the 2° C. estimate value.

When the weather amount of each measurement date/time is equal to or less than the minimum weather amount and there is the flag indicating having a heater, +1° C. estimate value is inputted to the 1° C. estimate value, and +2° C. estimate value is inputted to the 2° C. estimate value.

When the weather amount of each measurement date/time is equal to or less than the minimum weather amount and there is no flag indicating having a heater, the time estimate value is inputted to the 1° C. estimate value and the 2° C. estimate value.

The value of “1° C. estimate value−the estimate value” is inputted to 1° C. energy saving, and the value of “2° C. estimate value−the estimate value” is inputted to 2° C. energy saving. The total of 1° C. energy saving or the total of 2° C. energy saving is divided by the total of the time estimate values to calculate the energy saving rate of 1° C. energy saving or the energy saving rate of 2° C. energy saving.

In the manner described above, the energy saving effects by the behavior change when the air-conditioning setting temperature is changed by 1° C. and 2° C. are calculated.

The output unit totalizes the measurement results acquired from the database that includes the integrated data table of each measurement date/time and the total data table, and displays the results in a table and a graph.

As has been described above, it is the main characteristic of the present disclosure to make it possible to easily and highly accurately perform energy conservation diagnosis of the building such as the energy savable amount, the energy savable rate, the demand reducible amount, and the energy saving effect by behavior change, and the like through analyzing the energy consumption and the weather data by using the original statistical method.

The system has such an advantage that it is possible to perform energy conservation diagnosis of a plurality of buildings simultaneously and instantly by putting the calculation programs in a package and performing collection of data as well as output of the analysis results via the network.

Further, the present disclosure can be performed with the energy consumption data of the building and the location data of the building, so that it is also possible to perform extraction of the building with the high energy saving effect by utilizing the information collected by electric power companies and gas companies.

The means for solving the problems disclosed herein provides an example of calculations, and it is to be noted that the present disclosure can be performed with other content than those disclosed and that the present disclosure includes the content occurred naturally to those skilled in the art. Further, while typical examples are discussed for the expression, method, and the like discussed herein, it is to be noted that the present disclosure is not limited to those and other expressions can be employed instead.

### Effects of Invention

The method of the present disclosure is capable of performing highly accurate estimation of the energy consumption of each usage in the building and calculation of the energy savable amount, the demand reducible amount, and the energy saving effect by the behavior change from the energy consumption data of the building and the location data of the building.

Estimation of the energy consumption of each usage in the building and calculation of the energy savable amount, the demand reducible amount, and the energy saving effect by the behavior change in the energy conservation diagnosis according to the present disclosure requires no special expert knowledge regarding the energy conservation diagnosis and the energy, and can be achieved by using the easily acquirable data.

Further, the energy conservation diagnosis of the present disclosure can be performed with the energy consumption data of the building and the location data of the building, so that it is possible to perform extraction of the building with the high energy saving effect by utilizing the information collected by electric power companies and gas companies.

### BRIEF DESCRIPTION OF THE DRAWINGS

FIG. 1 is a diagram schematically illustrating a method for embodying the present disclosure (embodiment);

FIG. 2 is a flowchart illustrating a schematic flow of a method for embodying an each-usage energy consumption estimation program of the present disclosure (embodiment);

FIG. 3 is a flowchart illustrating a flow of calculation of a data generation unit of the each-usage energy consumption estimation program (embodiment);

FIG. 4 is a flowchart illustrating a flow of calculation of an operating day/non-operating day determination unit of the each-usage energy consumption estimation program (embodiment);

FIG. 5 is a flowchart illustrating a flow of calculation of the operating day/non-operating day determination unit of the each-usage energy consumption estimation program (embodiment);

FIG. 6 is a flowchart illustrating a flow of calculation of a holiday-work determination unit of the each-usage energy consumption estimation program (embodiment);

FIG. 7 is a flowchart illustrating a flow of calculation of a regression equation calculation unit of the each-usage energy consumption estimation program (embodiment);

FIG. 8 is a flowchart illustrating a flow of calculation of a baseline estimation unit of the each-usage energy consumption estimation program (embodiment);

FIG. 9 is a flowchart illustrating a flow of calculation of the baseline estimation unit of the each-usage energy consumption estimation program (embodiment);

FIG. 10 is a flowchart illustrating a flow of calculation of the baseline estimation unit of the each-usage energy consumption estimation program (embodiment);

FIG. 11 is a flowchart illustrating a flow of calculation of the baseline estimation unit of the each-usage energy consumption estimation program (embodiment);

FIG. 12 is a flowchart illustrating a flow of calculation of a baseline correction unit of the each-usage energy consumption estimation program (embodiment);

FIG. 13 is a flowchart illustrating a flow of calculation of the baseline correction unit of the each-usage energy consumption estimation program (embodiment);

FIG. 14 is a flowchart illustrating a flow of calculation of the baseline correction unit of the each-usage energy consumption estimation program (embodiment);

FIG. 15 is a flowchart illustrating a flow of calculation of the baseline correction unit of the each-usage energy consumption estimation program (embodiment);

FIG. 16 is a flowchart illustrating a flow of calculation of the baseline correction unit of the each-usage energy consumption estimation program (embodiment);

FIG. 17 is a flowchart illustrating a flow of calculation of an each-usage energy consumption estimation unit of the each-usage energy consumption estimation program (embodiment);

FIG. 18 is a flowchart illustrating a flow of calculation of an energy savable amount calculation unit of an energy savable amount calculation program (embodiment);

FIG. 19 is a flowchart illustrating a flow of calculation of a demand reducible amount calculation unit of the energy savable amount calculation program (embodiment);

FIG. 20 is a flowchart illustrating a flow of calculation of an energy saving simulation program (embodiment);

FIG. 21 is a flowchart illustrating a flow of calculation of the energy saving simulation program (embodiment);

FIG. 22 is a chart illustrating operating day/non-operating day determination that is the result of calculation performed by an operating day/non-operating day determination unit of the each-usage energy consumption estimation program (embodiment);

FIG. 23A illustrates examples of each-usage energy consumption classified by time in a certain day of each month acquired as a result of performing the each-usage energy consumption estimation program, in which a star mark denotes an abnormal value that is the energy consumption larger than a time upper limit value, indicating that there is an event or abnormal operation of equipment consuming a lot of energy in the time zone with the star mark (embodiment);

FIG. 23B illustrates examples of each-usage energy consumption classified by time in a certain day of each month acquired as a result of performing the each-usage energy consumption estimation program, in which a star mark denotes an abnormal value that is the energy consumption larger than the time upper limit value, indicating that there is an event or abnormal operation of equipment consuming a lot of energy in the time zone with the star mark (embodiment);

FIG. 24 is a chart illustrating correlation between “ac” estimate values and air-conditioning energy consumption measurement values acquired as a result of performing the each-usage energy consumption estimation program (embodiment);

FIG. 25A is a graph illustrating energy savable amount and energy savable rate acquired as a result of performing the energy savable amount calculation program (embodiment);

FIG. 25B is a graph illustrating demand reducible amount acquired as a result of performing the energy savable amount calculation program (embodiment);

FIG. 25C is a graph illustrating the energy saving effect acquired by changing the setting temperature acquired as a result of performing the energy saving simulation program (embodiment); and

FIG. 26 is a table for describing definitions of terms used in the present disclosure.

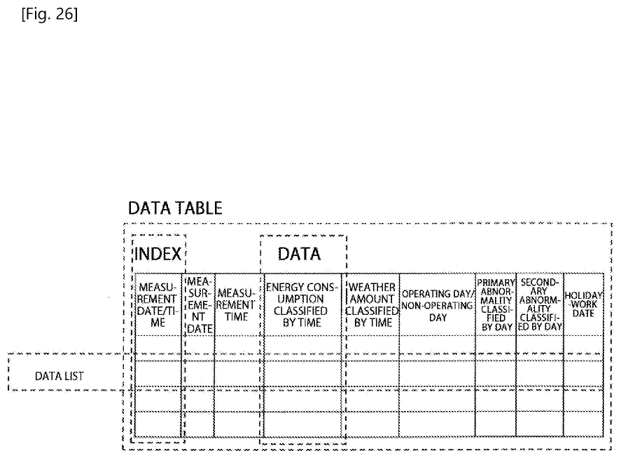

### DETAILED DESCRIPTION OF THE EMBODIMENTS

Hereinafter, specific modes of embodiments according to the present disclosure will be described by referring to the accompanying drawings.

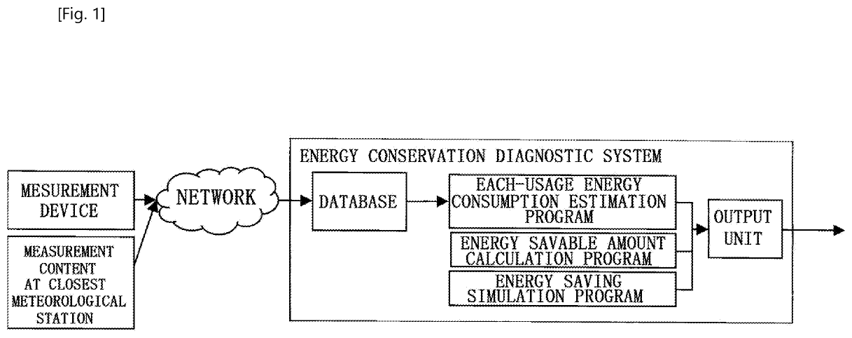

As illustrated in FIG. 1, an energy conservation diagnostic system according to the present disclosure is configured with: a database that collects and records energy consumption data and measurement content of a meteorological station via a network; an each-usage energy consumption estimation program for calculating the energy consumption of each usage by using the energy consumption data and the weather data recorded on the database; and an energy saving simulation program for calculating an energy savable amount and a demand reducible amount; an energy saving simulation program for calculating an energy saving effect achieved by behavior change and the like; and an output unit that outputs calculation results.

The database collects and records the energy consumption data and the measurement content of the meteorological station, and further records calculation results of the each-usage energy consumption estimation program, the energy savable amount calculation program, and the energy saving simulation program.

The energy consumption data is acquired by collecting the values measured by measurement devices via the network, and recorded by having the measured date/time as the index. A smart meter for measurement may be considered as the measurement device, and cumulative consumption or consumption within a measurement interval may be considered as the values to be measured.

Further, it is also possible to organize the energy consumption data recorded separately on a table format, record the table directly on the database via the network, and perform energy conservation diagnosis.

The database collects the measurement content of the meteorological station located at a point closest to the location of the building via the network, and records the content by having the measured date/time as the index. The measurement content includes values measured by the meteorological station, such as ambient temperature, humidity, atmospheric pressure, and the like.

Calculation is performed along the calculation logic of the energy conservation diagnostic system by using the data on the database. The calculation logic of the energy conservation diagnostic system is configured with the each-usage energy consumption estimation program, the energy savable amount program, and the energy saving simulation program, and results calculated according to those programs are outputted from the output unit.

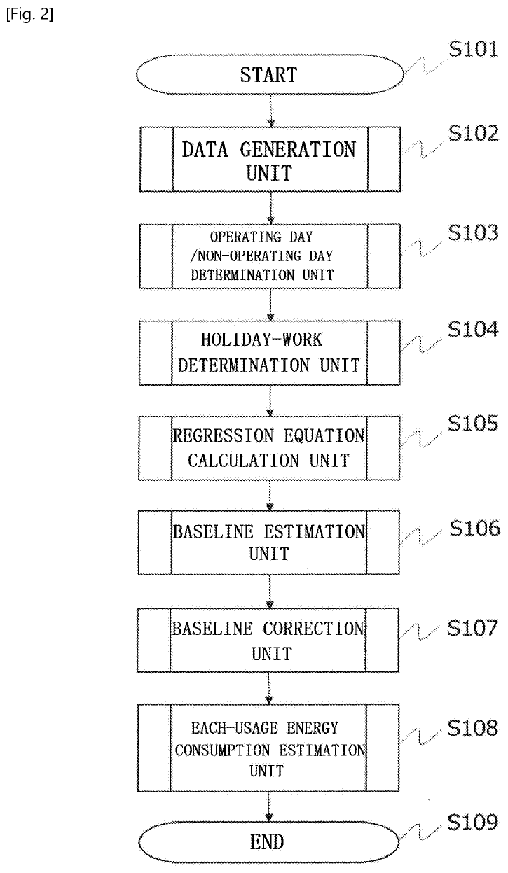

FIG. 2 is a flowchart illustrating an outline of the each-usage energy consumption estimation program. The each-usage energy consumption estimation program is configured with seven units that are a data generation unit (S102), an operating day/non-operating day determination unit (S103), a holiday-work determination unit (S104), a regression equation calculation unit (S105), a baseline estimation unit (S106), a baseline correction unit (S107), and an each-usage energy consumption estimation unit (S108).

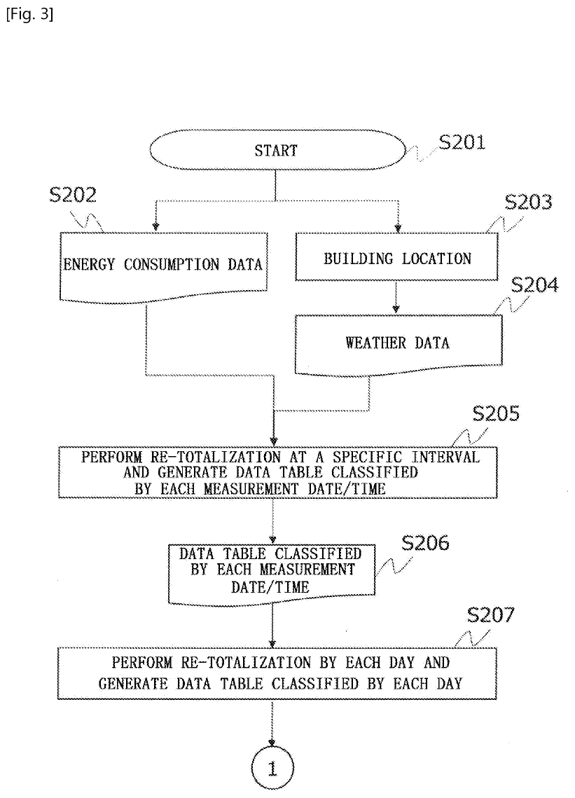

The data generation unit will be described by referring to the flowchart of FIG. 3.

Estimation of the energy consumption of each usage is started based on the energy consumption data and the location of the building (S201).

The energy consumption data recorded on the database and acquired via the network is extracted to prepare for an analysis (S202). When the measured value is the cumulative consumption, a differential value is calculated to acquire the consumption within a measurement interval.

The weather data of the meteorological station closest to the location of the building is extracted from the database for the same period as that of the energy consumption to prepare for the analysis (S203 to S204).

The measurement interval of the energy consumption data and that of the weather data may be different, so that those are re-totalized at a specific interval and a data table classified by each measurement date/time is generated (S205 to S206). The specific interval herein is any setting such as 10-minute interval, 15-minute interval, 20-minute interval, 30-minute interval, and one-hour interval. While the shorter the interval, the higher the data accuracy, the data amount is also increased for that. Therefore, it is preferable to set the interval by taking the manageable data volume into account.

In the embodiment, the data/time at which re-totalization is performed is referred to as “measurement date/time” and used as the index of the database, and 30-minute interval is used in the Example.

The data table of each measurement date/time is re-totalized be each day to generate a data table classified by each day (S207, S221). The data generation unit is configured and performed in the manner described above.

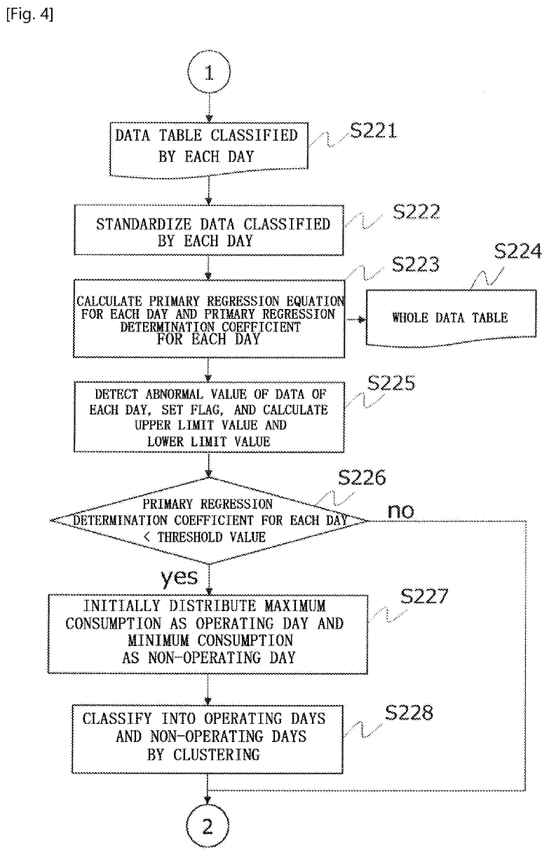

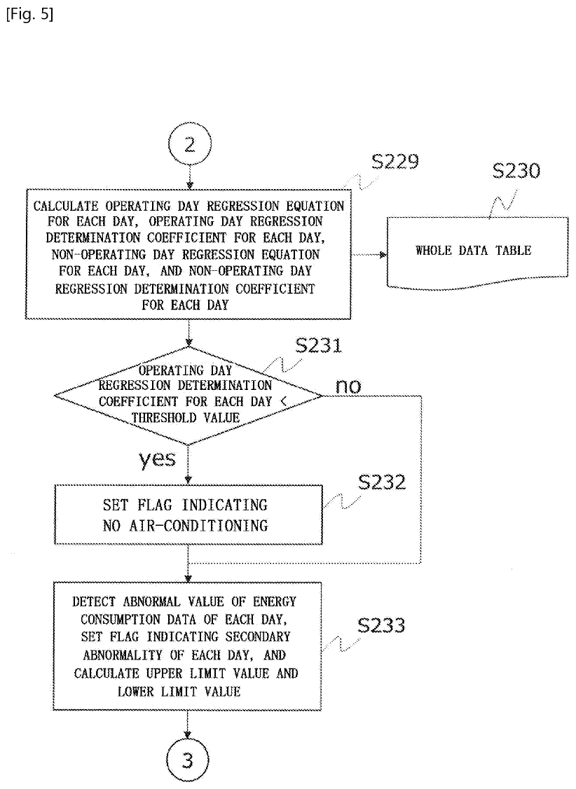

The operating day/non-operating day determination unit will be described by using the flowcharts of FIG. 4 and FIG. 5.

The energy consumption data and the weather data of the data table classified by each day are standardized (S222), and a primary regression equation for each day is generated and a primary regression determination coefficient for each day is calculated by using the standardized energy consumption data and weather data of the data table classified by each day (S223).

The primary regression determination coefficients of each day are recorded on the whole data table (S224), abnormal values of the energy consumption data are detected by using the estimate values derived from the primary regression equations of each day, and a primary abnormal flag of each day is set. Further, a statistical upper limit value and lower limit value are calculated (S225).

When the primary regression determination coefficient for each day is smaller than a set threshold value, the measurement days are classified into operating day and non-operating day. When the primary regression determination coefficient for each day is equal to or larger than the threshold value, all the measurement days are classified as the operating day (S226).

For classifying the measurement days into the operating days and the non-operating days, initial distribution of the operating days and non-operating days is performed (S227).

As the method for initial distribution, there is a method which distributes the measurement day where the energy consumption is the maximum of each month as the operating day and the measurement day of the minimum value as the non-operating day while excluding the measurement day of the primary abnormal flag of each day, and there is also a method which divides the weather data into four equal pieces between the maximum value and the minimum value, and distributes the measurement day where the energy consumption is the maximum value among the divided pieces as the operating day, and the measurement day of the minimum value as the non-operating day.

In this case, used is the method which distributes the measurement day where the energy consumption is the maximum of each month as the operating day and the measurement day of the minimum value as the non-operating day.

By having initially distributed days as training data, the remaining measurement days are classified into the operating days and non-operating days by using a clustering method from a scatter plot having the weather data as the independent variable and the energy consumption data as the dependent variable (S228).

In this case, a kernel support vector machine method is used as the clustering method, the kernel is calculated by using a cubic of a radial basis function and an independent variable, and the calculation result of higher correlation between the time estimate value and the energy consumption data of each measurement date/time is employed.

Regression is performed by taking the weather data as the independent variable and the energy consumption data as the dependent variable separately for the operating day and non-operating day to calculate the operating day regression equation for each day, the operating day regression determination coefficient for each day, the non-operating regression equation for each day, and the non-operating day regression determination coefficient for each day (S229).

The calculated operating day regression determination coefficient for each day and the non-operating regression equation for each day are recorded on the whole table (S230).

When the operating day regression determination coefficient for each day is smaller than the set threshold value, a flag indicating that there is no air-conditioning in the building is set. (S231 to S232).

The abnormal value of the energy consumption of each day is detected by using the operating day regression equation for each day and the non-operating day regression equation for each day separately for the operating day and the non-operating day, a secondary abnormal flag of each day is set for the energy consumption of the abnormal value, and the statistical upper value and the lower limit value are calculated (S233). The operating day/non-operating day determination unit is configured and performed in the manner described above.

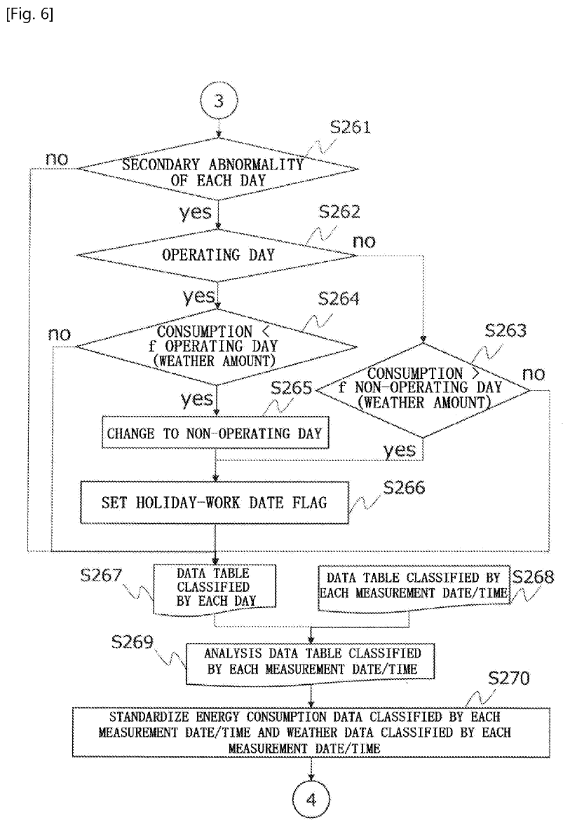

The holiday-work determination unit will be described by using the flowchart of FIG. 6.

Processing is performed targeted on the data list of the secondary abnormal flag of each day (S261).

When the energy consumption is smaller than the estimate value of the secondary operating day regression equation for each day in a case of the operating day, the operating day is changed to the non-operating day and a holiday-work date flag is set (S262, S264 to S266).

When the energy consumption is larger than the estimate value of the secondary operating day regression equation for each day in a case of the non-operating day, a holiday-work date flag is set (S262, S263, and S266).

The data table classified by each day and the data table classified by each measurement date/time are integrated to generate the analysis data table of each measurement date/time (S267 to S269).

The energy consumption data of each measurement date/time and the weather data of each measurement date/time are standardized (S270). The holiday-work determination unit is configured and performed in the manner described above.

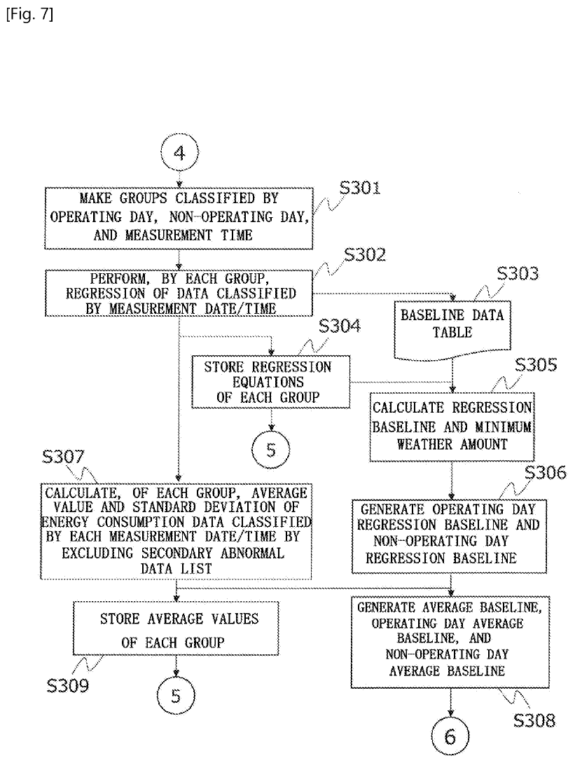

The regression equation calculation unit will be described by using the flowchart of FIG. 7. The operating day, the non-operating day, and the measurement time are combined, and the analysis data table of each measurement date/time is put into groups classified by the operating day, the non-operating day, and the measurement time (S301).

“Measurement time” herein indicates a specific period of time in which the data generation unit performs totalization.

Specifically, when the measurement time is set as one-hour interval, for example, it is defined as “24 hours÷1 hour×2 (operating day and non-operating day)” because there are operating days and non-operating days, so that 48 groups are generated. When the measurement time is set as 30-minute interval, it is defined as “60 minutes÷30 minutes×24×2 (operating day and non-operating day)”, so that 96 groups are generated.

Excluding the secondary abnormality data list of each day, regression is performed by having the weather data of each measurement date/time as the independent variable and having the time energy consumption data of each measurement date/time as the dependent variable to calculate the regression equation for each group classified by operating days, non-operating days, and measurement time (S302).

The time regression determination coefficients are recorded on the baseline data table of each group classified by operating days, non-operating days, and measurement time (S303).

The regression equations of each group classified by operating days, non-operating days, and measurement time are recorded on a memory (S304).

The minimum value of the estimate values within a range of the weather data of each group classified by operating days, non-operating days, and measurement time is calculated by using the regression equations of each group classified by operating days, non-operating days, and measurement time. The minimum value of the estimate values of each group classified by operating days, non-operating days, and measurement time is recorded on the baseline database as the regression baseline and the value of the weather data deriving the minimum estimate value is recorded on the baseline database as the minimum weather amount (S305).

In the baseline data table, operating day regression baseline and non-operating day regression baseline are generated of each measurement time. For the operating day regression baseline, the value of the regression baseline of the operating day is inputted on the data list of the same measurement time irrespective of the operating day and the non-operating day. Similarly, for the non-operating day regression baseline, the value of the regression baseline of the non-operating day is inputted on the data list of the same measurement time irrespective of the operating day and the non-operating day (S306).

Excluding the secondary abnormality data list of each day, average values (time average values) and standard deviations of the time energy consumption data of each measurement date/time are calculated of each group classified by operating days, non-operating days, and measurement time, and the average values are taken as the average baseline. The operating day average baseline and the non-operating day baseline are generated of each measurement time (S307 to S308).

The average values of each group classified by operating days, non-operating days, and measurement time are calculated, and the average values are recorded on the memory (S309).

The regression equation calculation unit is configured and performed in the manner described above.

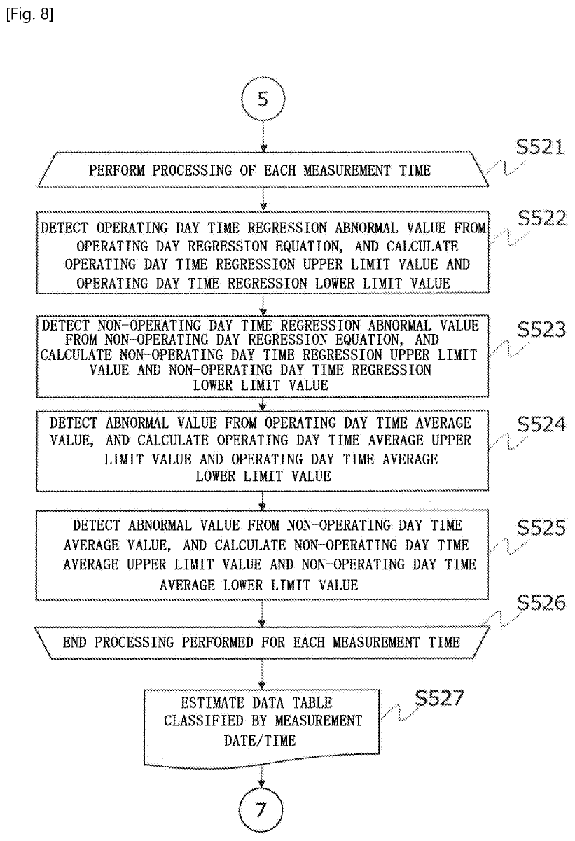

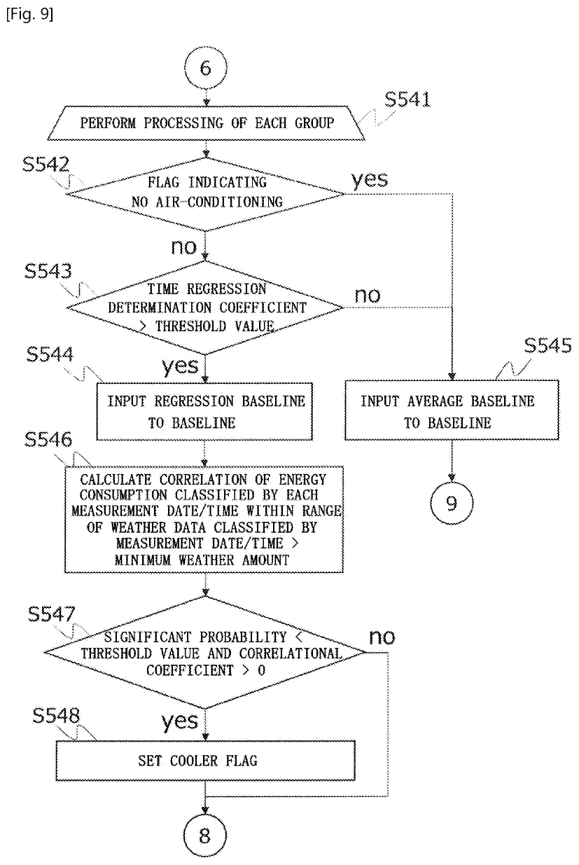

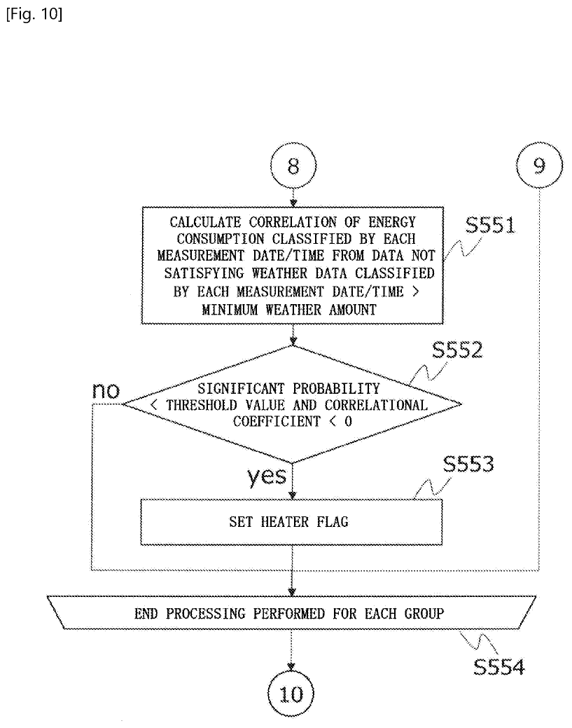

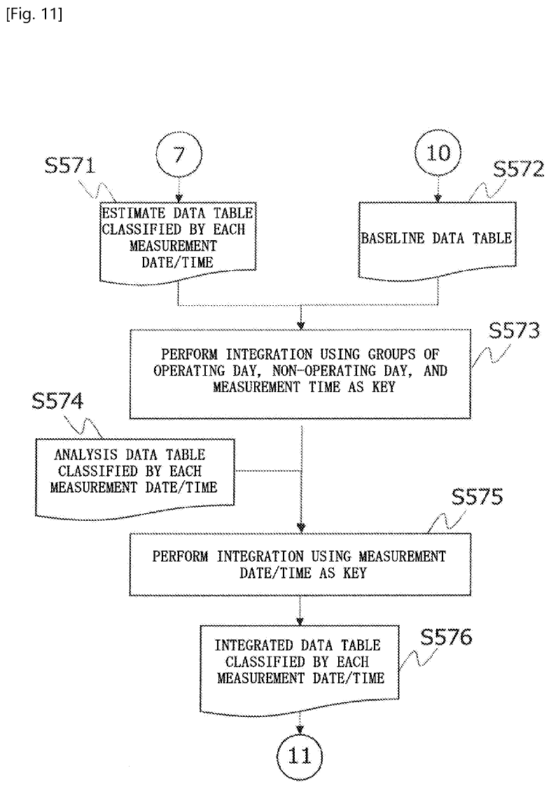

The baseline estimation unit will be described by using FIG. 8 to FIG. 11.

For baseline estimation, two methods, a loop (method) processed for each measurement time and a loop (method) processed for each group are executed separately or executed in parallel.

Loop processing of S522 to S525 is performed for each measurement time by using the analysis data table classified by each measurement date/time. The operating day time regression estimate values are calculated from the operating day regression equations of each measurement time. The distribution function of variance is acquired from the operating day time regression estimate value data and energy consumption data filed by the operating days, variance of all the operating day time regression estimate values and energy consumption data is applied to the distribution function to detect abnormal values, and operating day time regression abnormal flags are set. Further, an operating day time regression upper limit value is calculated as the statistical upper limit value, and an operating day time regression lower limit value is calculated as the statistical lower limit value (S522).

The non-operating day time regression estimate values are calculated from the non-operating day regression equations of each measurement time. The distribution function of variance is acquired from the non-operating day time regression estimate value data and energy consumption data filed by the non-operating days, variance of all the non-operating day time regression estimate values and energy consumption data is applied to the distribution function to detect abnormal values, and non-operating day time regression abnormal flags are set. Further, a non-operating day time regression upper limit value is calculated as the statistical upper limit value, and a non-operating day time regression lower limit value is calculated as the statistical lower limit value (S523).

The abnormal value of the energy consumption is detected from the operating day time average value and the standard deviation, and an operating day time average abnormal flag is set. Further, an operating day time average upper limit value is calculated as the statistical upper limit value, and an operating day time average lower limit value is calculated as the statistical lower limit value (S524).

The abnormal value of the energy consumption is detected from the non-operating day time average value and the standard deviation, and a non-operating day time average abnormal flag is set. Further, a non-operating day time average upper limit value is calculated as the statistical upper limit value, and a non-operating day time average lower limit value is calculated as the statistical lower limit value (S525). Then, the loop processing of the next measurement time is performed (S526).

An estimation data table of each measurement date/time is generated, and the calculation results are recorded therein (S527).

The loop processing of S542 to S553 is performed by using the baseline data table of each group classified by the operating days, non-operating days, and measurement time. The average baseline is inputted for the baseline when there is a flag indicating no air-conditioning or when the time regression determination coefficient is equal to or less than the set threshold value, and the regression baseline is inputted for the baseline in other cases (S542 to S545).

When correlation between the energy consumption data of each measurement date/time and the weather data is calculated within a range where the weather data of each measurement date/time is larger than the minimum weather amount. When the correlation is recognized as statistically significant and also a correlation coefficient is a positive value, a cooler flag is set (S546 to S548). Correlation between the energy consumption data of each measurement date/time and weather data is calculated within a range where the weather data of each measurement date/time is equal to or smaller than the minimum weather amount. When the correlation is recognized as statistically significant and also a correlation coefficient is a negative value, a heater flag is set (S551 to S553). Then, the loop processing is performed for the next group classified by the operating days, non-operating days, and measurement time (S554).

The estimate data table of each measurement date/time and the baseline data table are integrated by having each group classified by the operating days, non-operating days, and measurement time as the key (S571 to S573). The analysis data table of each measurement date/time and the data table integrated in S571 to S573 are integrated by having the measurement date/time as the key to generate the integrated data table classified by each measurement date/time (S574 to S576). The baseline estimation unit is configured and performed in the manner described above.

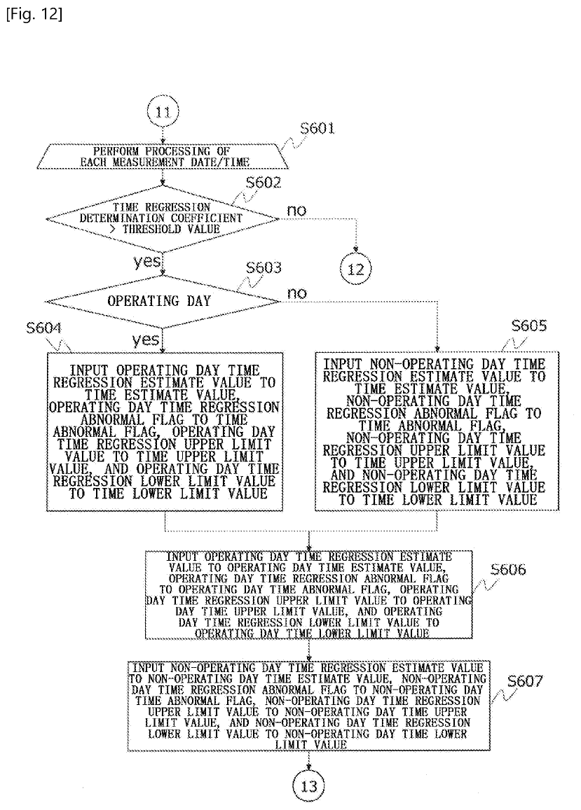

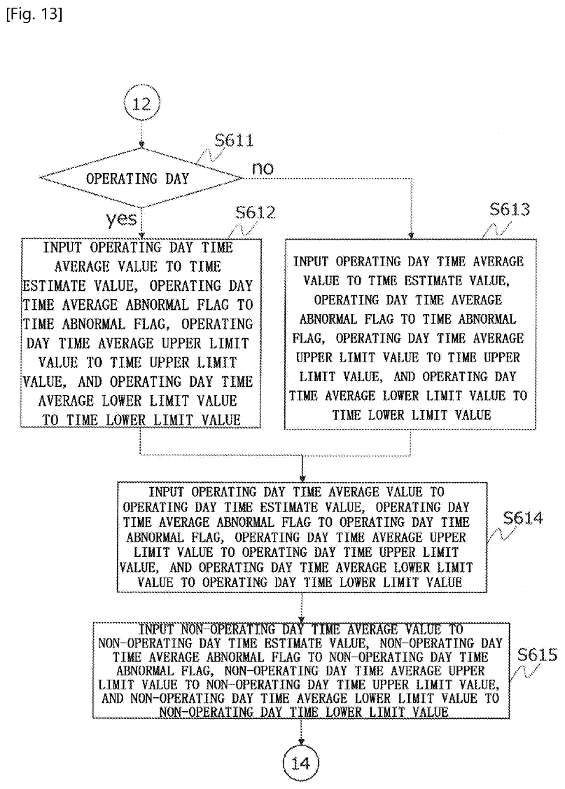

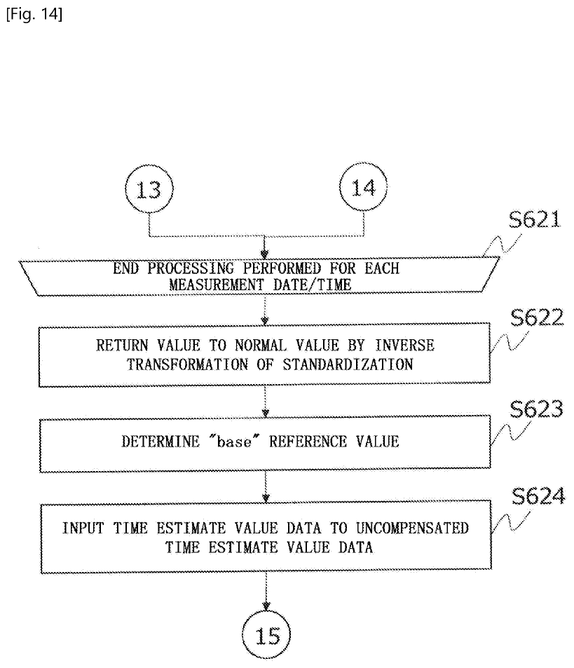

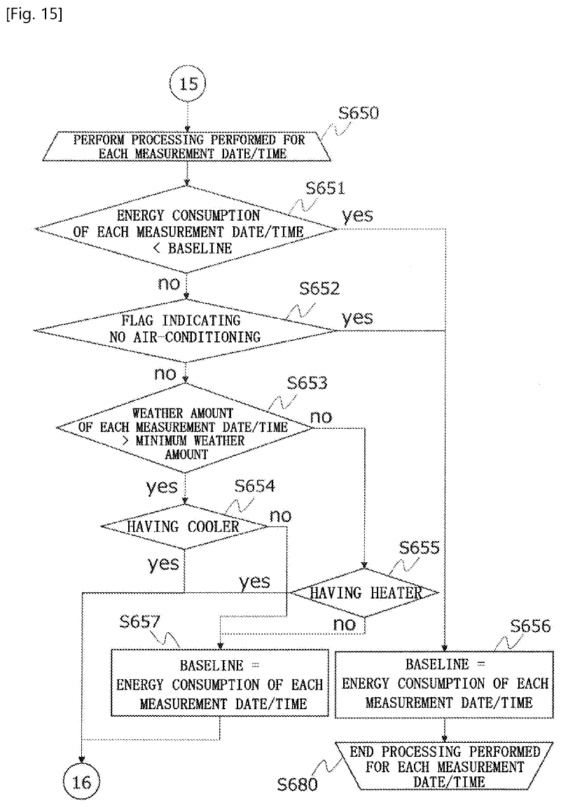

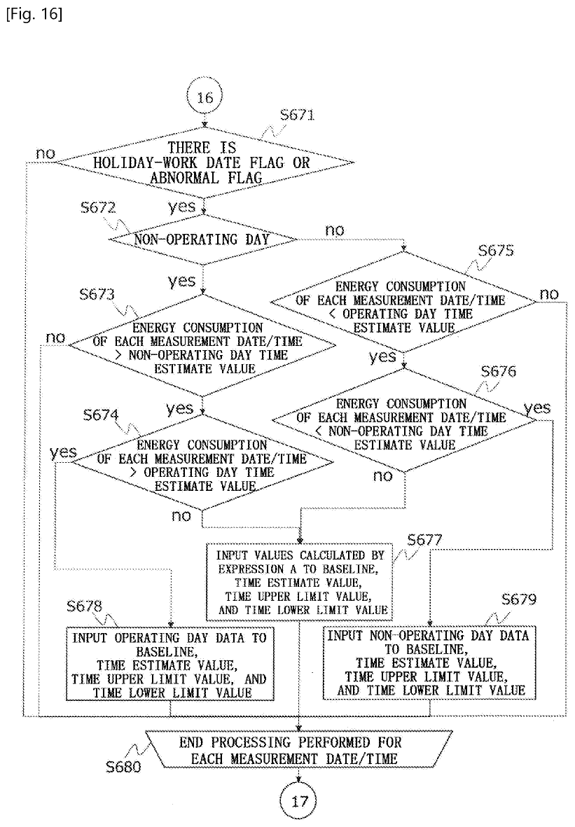

The baseline correction unit will be described by using the flowcharts of FIG. 12 to FIG. 16.

The loop processing of S602 to S615 is performed for each measurement date/time on the integrated data table classified by each measurement date/time.

When the time regression determination coefficient is larger than the set threshold value and when it is the operating day, the operating day time regression estimate value is inputted to the time estimate value, the operating day time regression abnormal flag is inputted to the time abnormal flag, the operating day time regression upper limit value is inputted to the time upper limit value, and the operating day time regression lower limit value is inputted to the time lower limit value (S602 to S604).

When the time regression determination coefficient is larger than the set threshold value and when it is the non-operating day, the non-operating day time regression estimate value is inputted to the time estimate value, the non-operating day time regression abnormal flag is inputted to the time abnormal flag, the non-operating day time regression upper limit value is inputted to the time upper limit value, and the non-operating day time regression lower limit value is inputted to the time lower limit value (S602, S603, and S605).

When the time regression determination coefficient is larger than the set threshold value, the operating day time regression estimate value is inputted to the operating day time estimate value, the operating day time regression abnormal flag is inputted to the operating day time abnormal flag, the operating day time regression upper limit value is inputted to the operating day time upper limit value, and the operating day time regression lower limit value is inputted to the operating day time lower limit value (S606). Further, the non-operating day time regression estimate value is inputted to the non-operating day time estimate value, the non-operating day time regression abnormal flag is inputted to the non-operating day time abnormal flag, the non-operating day time regression upper limit value is inputted to the non-operating day time upper limit value, and the non-operating day time regression lower limit value is inputted to the non-operating day time lower limit value (S607).

When the time regression determination coefficient is equal to or less than the set threshold value and when it is the operating day, the operating day time average value is inputted to the time estimate value, the operating day time average abnormal flag is inputted to the time abnormal flag, the operating day time average upper limit value is inputted to the time upper limit value, and the operating day time average lower limit value is inputted to the time lower limit value (S602, S611 to S612).

When the time regression determination coefficient is equal to or less than the set threshold value and when it is the non-operating day, the non-operating day time average value is inputted to the time estimate value, the non-operating day time average abnormal flag is inputted to the time abnormal flag, the non-operating day time average upper limit value is inputted to the time upper limit value, and the non-operating day time average lower limit value is inputted to the time lower limit value (S602, S611, and S613).

When the time regression determination coefficient is equal to or less than the set threshold value, the operating day time average value is inputted to the operating day time estimate value, the operating day time average abnormal flag is inputted to the operating day time abnormal flag, the operating day time average upper limit value is inputted to the operating day time upper limit value, and the operating day time average lower limit value is inputted to the operating day time lower limit value (S614). Further, the non-operating day time average value is inputted to the non-operating day time estimate value, the non-operating day time average abnormal flag is inputted to the non-operating day time abnormal flag, the non-operating day time average upper limit value is inputted to the non-operating day time upper limit value, and the non-operating day time average lower limit value is inputted to the non-operating day time lower limit value (S615).

After performing the loop processing of the measurement date/time from S607 to S615, the loop processing is ended (S621).

The energy consumption data of each measurement date/time and the weather data of each measurement date/time are returned to normal values by inverse transformation of standardization (S622).

The minimum value of the baseline excluding the data list of the abnormal flags of each measurement date/time is taken as “base” reference value (S623).

The time estimate value data is inputted to uncorrected time estimate value data (S624).

The loop processing of S651 to S679 is performed of each measurement date/time on the integrated data table classified by each measurement date/time.

When the energy consumption of each measurement date/time is smaller than the baseline or there is a flag indicating no air-conditioning, the energy consumption of each measurement date/time is inputted to the baseline, and the loop processing of the next measurement date/time is performed (S651 to S652, S656, and S680).

When there is no flag indicating having a cooler in a case where the energy consumption of each measurement date/time is equal to or larger than the baseline, there is no flag indicating no air-conditioning and the weather amount of each measurement date/time is larger than the minimum weather amount, the energy consumption of each measurement date/time is inputted to the baseline (S651 to S654, and S657).

When there is no flag indicating a heater in a case where the energy consumption of each measurement date/time is equal to or larger than the baseline, there is no flag indicating no air-conditioning and the weather amount of each measurement date/time is equal to or less than the minimum weather amount, the energy consumption of each measurement date/time is inputted to the baseline (S651 to S653, and, S655, and S657).

When there is neither the holiday-work date flag nor the abnormal flag, processing of the next measurement date/time is performed (S671, S680).

When there is the holiday-work date flag or the abnormal flag, it is the non-operating day, and the energy consumption of each measurement date/time is equal to or less than the non-operating day time estimate value, the loop processing of the next measurement date/time is performed (S671 to S673, and S680).

When there is the holiday-work date flag or the abnormal flag, it is the non-operating day, the energy consumption of each measurement date/time is larger than the non-operating day time estimate value, and the energy consumption of each measurement date/time is larger than the operating day time estimate value, the operating day estimate value is inputted to the time estimate value, the operating day time upper limit value is inputted to the time upper limit value, and the operating day time lower limit value is inputted to the time lower limit value (S671 to S674, and S678).

When there is the holiday-work date flag or the abnormal flag, it is the non-operating day, the energy consumption of each measurement date/time is larger than the non-operating day time estimate value, and the energy consumption of each measurement date/time is equal to or less than the operating day time estimate value, values calculated by expression A are inputted (S671 to S674, and S677).

Expression A includes following formulae 3 to 6.

Baseline=operating day baseline×energy consumption of each measurement date/time/operating day time estimate value [Expression 3]

Time estimate value=energy consumption of each measurement date/time [Expression 4]

Time upper limit value=operating day time upper limit value×energy consumption of each measurement date/time/operating day time estimate value [Expression 5]

Time lower limit value=operating day time lower limit value×energy consumption of each measurement date/time/operating day time estimate value [Expression 6]

When there is the holiday-work date flag or the abnormal flag, it is not the non-operating day, and the energy consumption of each measurement date/time is equal to or larger than the operating day time estimate value, the loop processing of the next measurement date/time is performed (S671 to S672, S675, and S680).

When there is the holiday-work date flag or the abnormal flag, it is not the non-operating day, the energy consumption of each measurement date/time is smaller than the operating day time estimate value, and the energy consumption of each measurement date/time is smaller than the non-operating day time estimate value, the non-operating day estimate value is inputted to the time estimate value, the non-operating day time upper limit value is inputted to the time upper limit value, and the non-operating day time lower limit value is inputted to the time lower limit value (S671, S672, S675, S676, and S679).

When there is the holiday-work date flag or the abnormal flag, it is not the non-operating day, the energy consumption of each measurement date/time is smaller than the operating day time estimate value, and the energy consumption of each measurement date/time is equal to or larger than the non-operating day time estimate value, values calculated by expression A are inputted (S671, S672, S675, S676, and S677).

The loop processing of the next measurement date/time is performed (S680). The baseline correction unit is configured and performed in the manner described above.

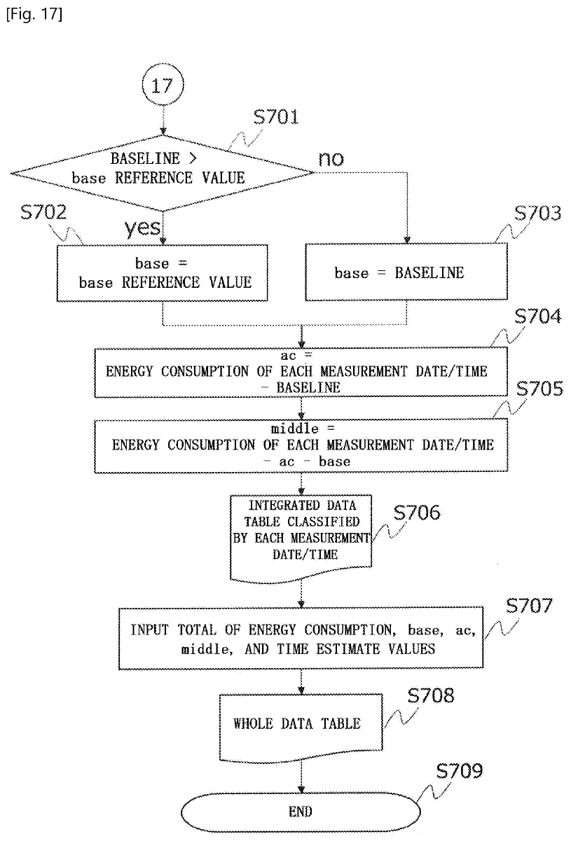

The each-usage energy consumption estimation unit will be described by using the flowchart of FIG. 17.

When the baseline is larger than the base reference value, the base reference value is inputted to “base” (S701 to S702).

When the baseline is equal to or less than the base reference value, the baseline is inputted to “base” (S701, S703).

The value of “energy consumption of each measurement date/time−baseline” is inputted to “ac” (S704).

The value of “energy consumption of each measurement date/time−ac−base”, that is, the value acquired by subtracting “ac” and “base” from the energy consumption of each measurement date/time is inputted to “middle” (S705).

The calculated values are recorded in the integrated data table classified by each measurement date/time (S706).

The energy consumption of each measurement date/time, “base”, “ac”, “middle”, and the total value of the time estimate values are recorded on the whole data table (S707 to S708). The each-usage energy consumption estimation unit is configured and performed in the manner described above.

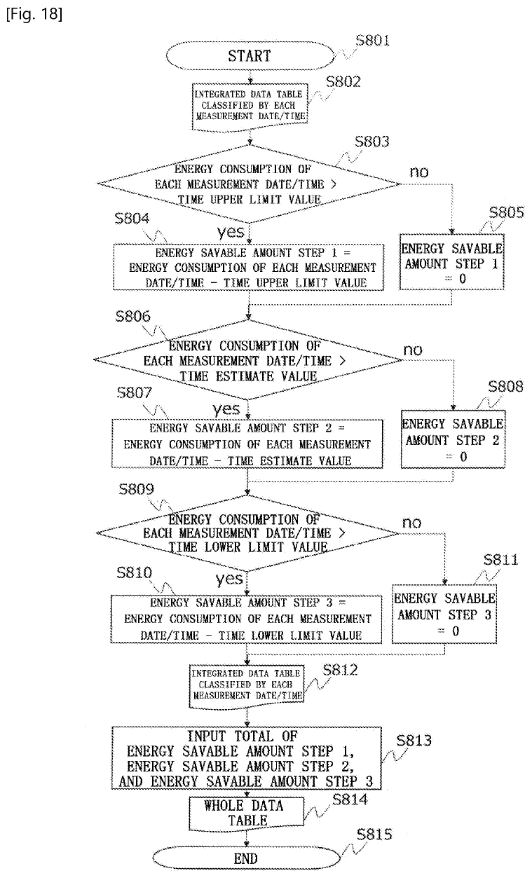

The energy savable amount calculation program is configured with an energy savable amount calculation unit and a demand reducible amount calculation unit. The energy savable amount calculation unit will be described by using the flowchart of FIG. 18.

The energy savable amount is calculated by using the integrated data table classified by each measurement date/time (S801 to S802).

When the energy consumption of each measurement date/time is larger than the time upper limit value, the value of “energy consumption of each measurement date/time−the time upper limit value” is inputted to the energy savable amount (step 1). In other cases, 0 (zero) is inputted to the energy savable amount (step 1) (S803 to S805).

When the energy consumption of each measurement date/time is larger than the time estimate value, the value of “energy consumption of each measurement date/time−the time estimate value” is inputted to the energy savable amount (step 2). In other cases, 0 (zero) is inputted to the energy savable amount (step 2) (S806 to S808).

When the energy consumption of each measurement date/time is larger than the time lower limit value, the value of “energy consumption of each measurement date/time−the time lower limit value” is inputted to the energy savable amount (step 3). In other cases, 0 (zero) is inputted to the energy savable amount (step 3) (S809 to S811).

The integrated data table classified by each measurement date/time is updated (S812).

The total value of the energy savable amount (step 1), the energy savable amount (step 2), and the energy savable amount (step 3) is inputted to the whole data table, and the processing is ended (S813 to S815). The energy savable amount calculation unit is configured and performed in the manner described above.

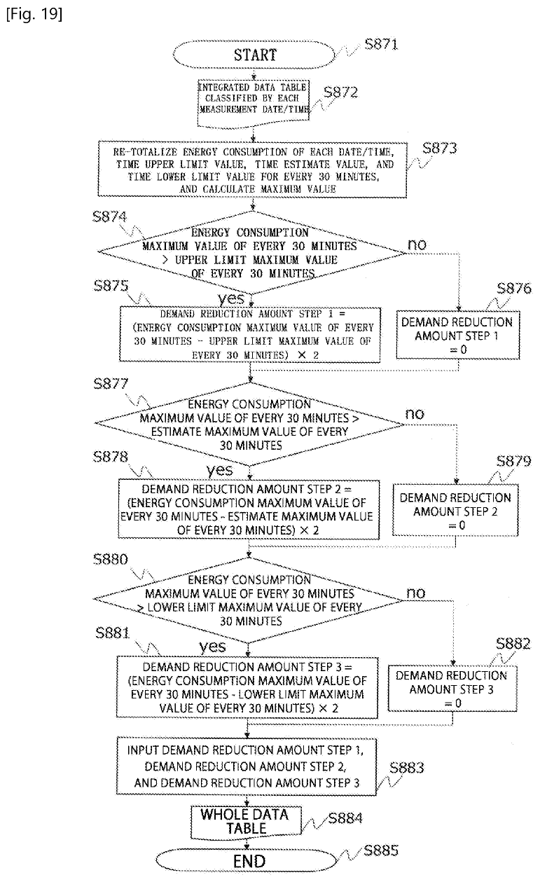

The demand reducible amount calculation unit will be described by using the flowchart of FIG. 19.

The demand reducible amount is calculated by using the integrated data table classified by each measurement date/time (S871 to S872).

The energy consumption of each measurement date/time, the time upper limit value, the time estimate value, and the time lower limit value are re-totalized by every 30 minutes, and the maximum values are calculated (S873).

When energy consumption maximum value of every 30 minutes is larger than upper limit maximum value of every 30 minutes, the value of “(energy consumption maximum value of every 30 minutes−upper limit maximum value of every 30 minutes)×2” is inputted to the demand reduction amount (step 1). In other cases, 0 (zero) is inputted to the demand reduction amount (step 1) (S874 to S876).

When the energy consumption maximum value of every 30 minutes is larger than the estimate maximum value of every 30 minutes, the value of “(energy consumption maximum value of every 30 minutes−estimate maximum value of every 30 minutes)×2” is inputted to the demand reduction amount (step 2). In other cases, 0 (zero) is inputted to the demand reduction amount (step 2) (S877 to S879).

When the energy consumption maximum value of every 30 minutes is larger than the lower limit maximum value of every 30 minutes, the value of “(energy consumption maximum value of every 30 minutes−lower limit maximum value of every 30 minutes)×2” is inputted to the demand reduction amount (step 3). In other cases, 0 (zero) is inputted to the demand reduction amount (step 3) (S880 to S882).

The demand reduction amount (step 1), the demand reduction amount (step 2), and the demand reduction amount (step 3) are recorded on the whole data table, and the processing is ended (S883 to S885). The demand reducible amount calculation unit is configured and performed in the manner described above.

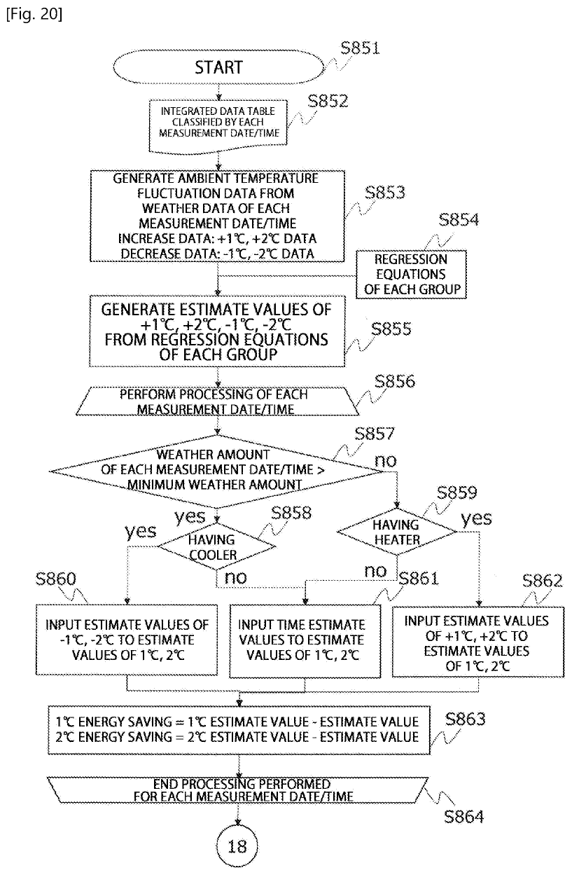

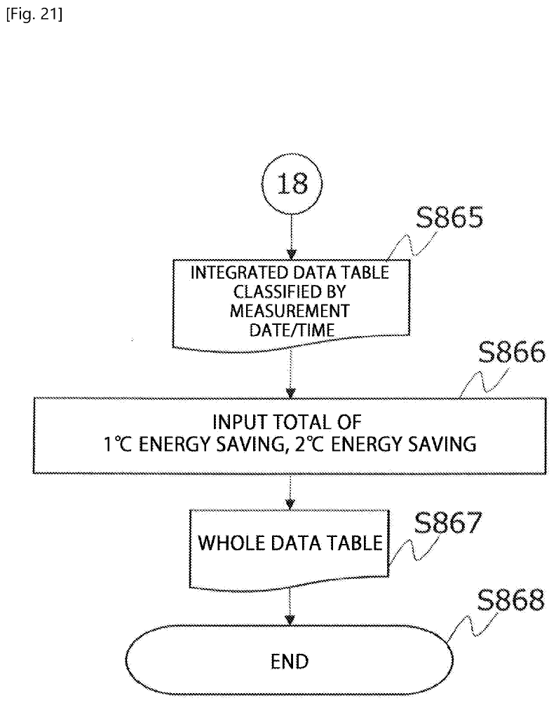

The energy saving simulation program will be described by using the flowcharts of FIG. 20 and FIG. 21.

The energy saving effects by the behavior change when changing the air-conditioner setting temperature are calculated by using the integrated data table classified by each measurement date/time (S851 to S852).

Note that +1° C. data increased by 1° C. in the ambient temperature from the weather data of each measurement time, +2° C. data increased by 2° C. in the ambient temperature, −1° C. data decreased by 1° C. in the ambient temperature, and −2° C. data decreased by 2° C. in the ambient temperature are generated (S853).

The weather data of +1° C., +2° C., −1° C., and −2° C. are substituted to each group by using the regression equations of each group classified by the operating days, non-operating days, and measurement time to generate the estimate values (S854 to S855).

The loop processing of S857 to S863 is performed for each measurement date/time (S856).

When the weather amount of each measurement date/time is larger than the minimum weather amount and there is the flag indicating having a cooler, −1° C. estimate value is inputted to the 1° C. estimate value, and −2° C. estimate value is inputted to the 2° C. estimate value (S857 to S858, and S860).

When the weather amount of each measurement date/time is equal to or less than the minimum weather amount and there is the flag indicating having a heater, +1° C. estimate value is inputted to the 1° C. estimate value, and +2° C. estimate value is inputted to the 2° C. estimate value (S857, S859, and S862).

When the weather amount of each measurement date/time is larger than the minimum weather amount and there is no flag indicating having a cooler, the time estimate value is inputted to the 1° C. estimate value and the 2° C. estimate value (S857, S858, and S861).

When the weather amount of each measurement date/time is equal to or less than the minimum weather amount and there is no flag indicating having a heater, the time estimate value is inputted to the 1° C. estimate value and the 2° C. estimate value (S857, S859, and S861).

The value of “1° C. estimate value−the estimate value” is inputted to 1° C. energy saving, and the value of “2° C. estimate value−the estimate value” is inputted to 2° C. energy saving (S863).

The processing of the next measurement date/time is performed (S864).

The integrated database classified by measurement date/time is updated (S865).

The total of 1° C. energy saving and the total of 2° C. energy saving are inputted to the whole data table, and the processing is ended (S866 to S868).

The output unit totalizes the measurement results acquired from the database that includes the integrated data table of each measurement date/time and the total data table, and displays the results in a table and a graph.

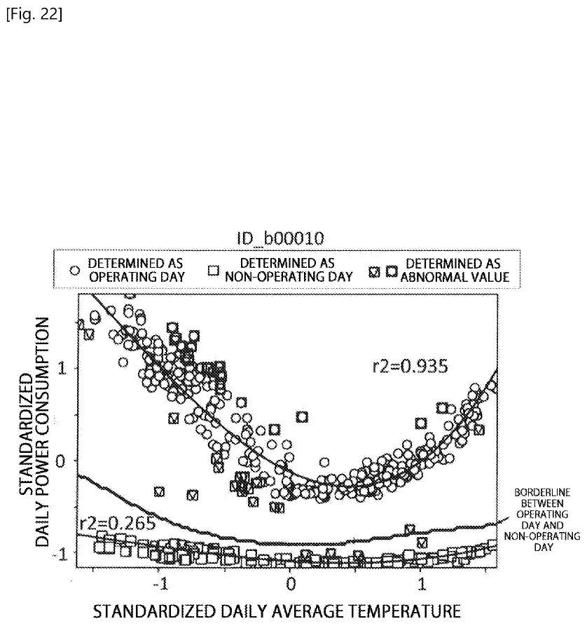

The results acquired by actually performing data processing according to the flow described above are presented in FIG. 22 to FIG. 25.

FIG. 22 is an example of operating day and non-operating day determination generated by using the embodiment of the present disclosure. Presented is the result acquired by: standardizing the average temperatures of each day and the electricity consumption of each day; performing kernel support vector machine by distributing the initial values to determine the operating days and the non-operating days; performing ridge regression separately on the operating days and the non-operating days; and fitting the variance thereof with the gamma distribution to determine the abnormal values. The range above the borderline between the operating day and the non-operating day indicates the operating days, while the range below the borderline indicates the non-operating days. The consumption expressed by a triangle in a square and the consumption expressed by a circle in a square indicate the abnormal values. The operating days have a high correlation with the temperatures (the determination coefficient is 0.935 in the operating days). The low determination coefficient (0.265) of the non-operating days indicates that the correlation with the temperatures is low because the air-conditioning is not used so that the influence by the temperature is small. Thereby, it can be found that determination of the operating days and the non-operating days is performed with extremely high accuracy.

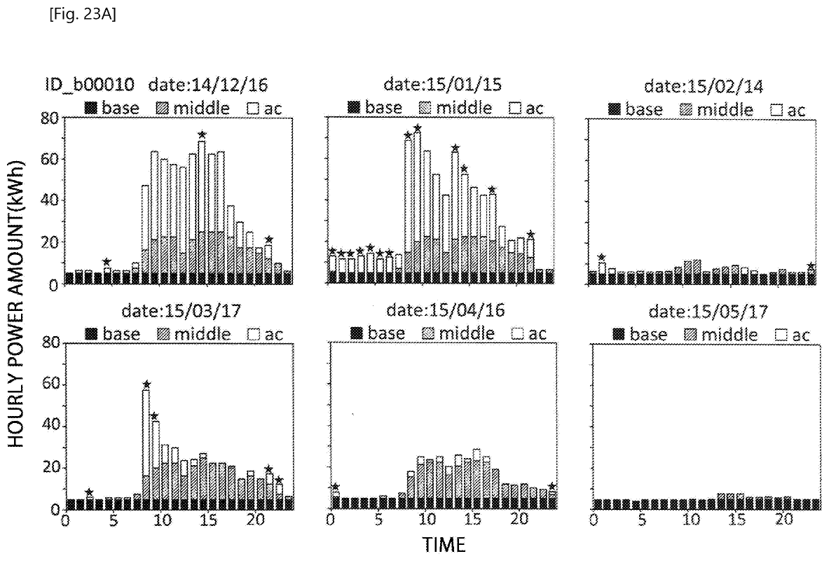

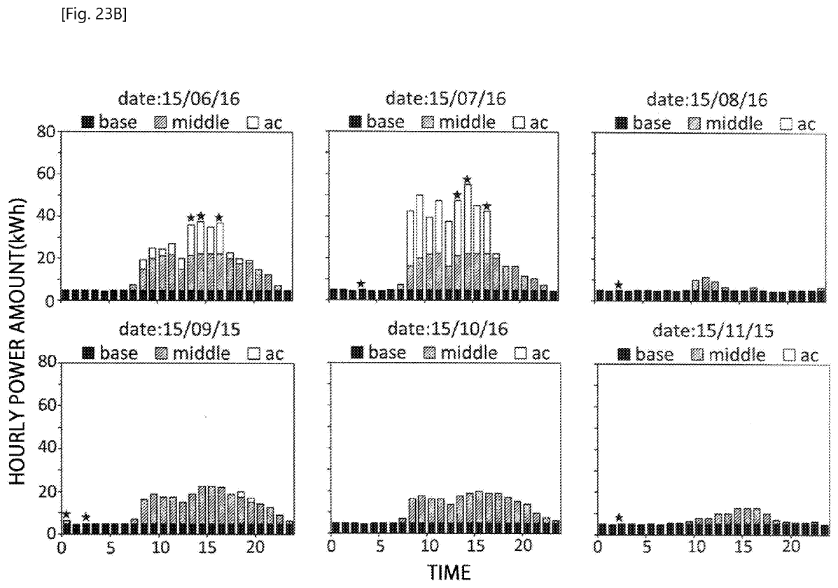

FIG. 23A and FIG. 23B provide graphs of energy consumption of each usage in each time of a certain day of each month outputted from the output unit by using the integrated data table classified by each measurement date/time. The horizontal axis indicates 0 (zero):00 to 24:00, the vertical axis is the energy amount, and each bar graph from the bottom side indicates “base”, “middle”, and “ac”. The six graphs in FIG. 23A are of December, January, and February from the upper left side, and the one in the lower right side is the graph of May. The six graphs in FIG. 23B are of June, July, and August from the upper left side, and the one in the lower right side is the graph of November. The star mark indicates the energy consumption of each measurement date/time larger than the time upper limit value. The star mark at the date/time indicates that there is an event causing an increase in the energy consumption or there is abnormal operation of the equipment, and indicates that a high energy saving effect can be acquired by taking energy conservation measures emphasizing on the date/time with the star mark.

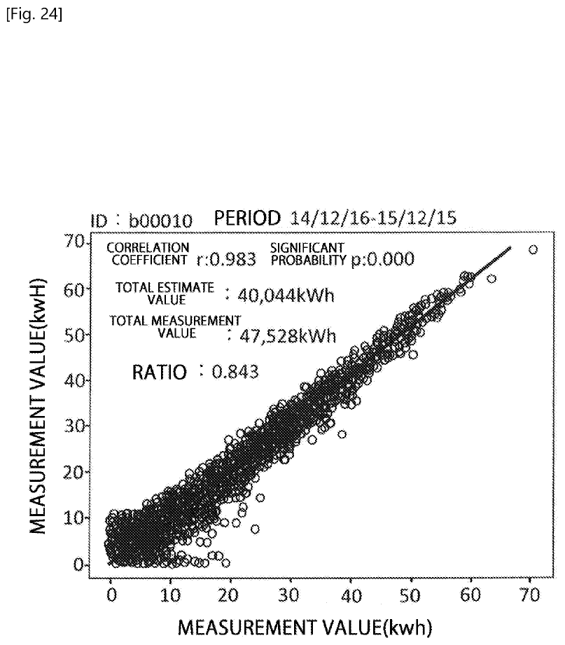

FIG. 24 illustrates the correlation between the ac estimate values and the air-conditioning energy consumption measurement values. The correlation coefficient is 0.983 that is an extremely high value, indicating that the accuracy of the estimate value of “ac” is extremely high.

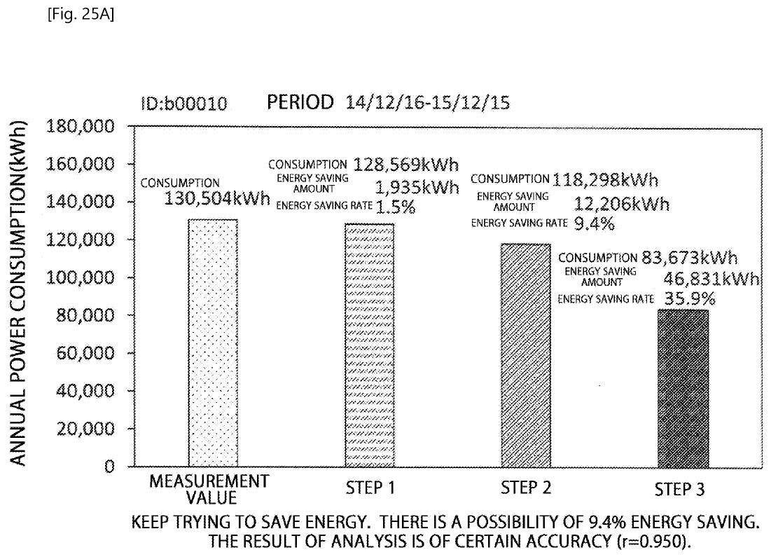

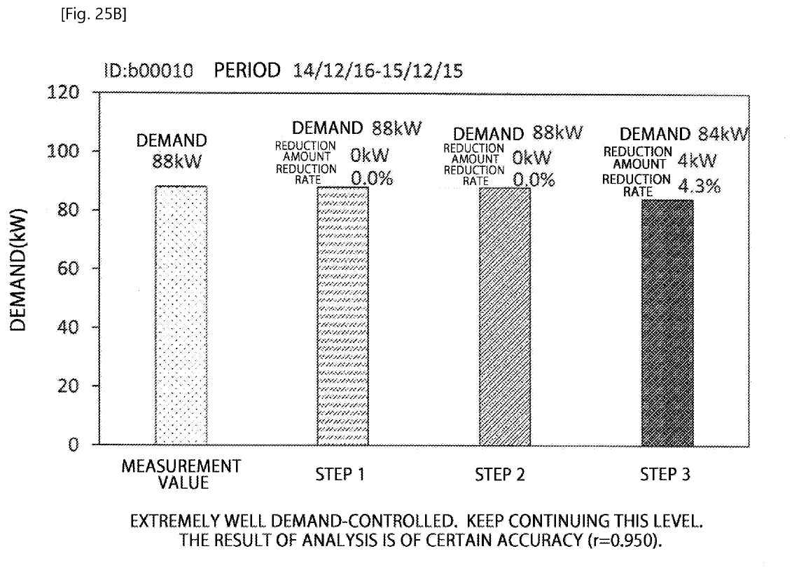

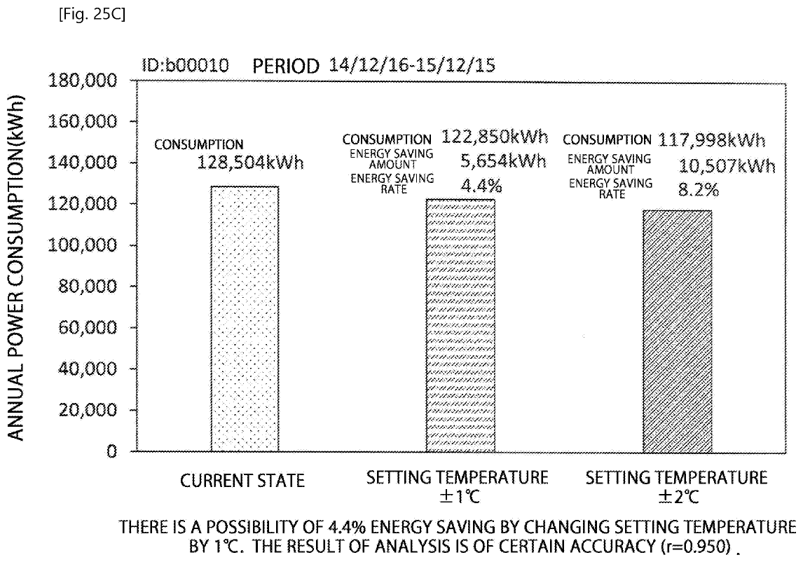

FIG. 25A illustrates the calculated result of the energy savable amount, FIG. 25B illustrates the calculated result of the demand reducible amount, and FIG. 25C illustrates the effects acquired by changing the air-conditioning setting temperatures.

FIG. 25A provides calculation examples of the energy savable amount of step 1 to step 3. The abnormal value is lowered to the upper limit of the estimate value including the statistical error in step 1, while the consumption larger than the estimate value is lowered to the estimate value in step 2. Further, in step 3, the consumption larger than the lower limit of the estimate values including the statistical error is lowered to the lower limit of the estimate values including the statistical error, so that step 3 can be considered as energy saving by patience. Energy saving of step 2 is set as the target herein, and a comment upon receiving the result is to be displayed on a screen. In addition to the total evaluation, there is some ingenuity put for maintaining motivation for saving energy such as expressing the potential value of the energy saving effect and the accuracy of the analysis results with gamma values, and the like.

FIG. 25B provides cases of the calculated results of the demand reducible amount, in which the conditions of step 1 to step 3 are set as in FIG. 25A. The measurement value is the same value as that of step 2, when the demand control is managed well.

FIG. 25C provides an example of energy savable amount by changing the setting temperatures, that is, by the behavior change. The regression equations for baseline estimation are used for calculation, and it is considered that change in the ambient temperature by 1° C. and change in the setting temperature by 1° C. are equivalent. The total evaluation, the potential value of the energy saving effect, and the accuracy of the analysis results are also presented, thereby making it possible to maintain the motivation for saving energy.

While the flow for achieving the embodiments and examples of the results thereof are presented above, it is possible with the present disclosure to acquire substantially the same results regardless of who and when the present disclosure is performed, because the present disclosure performs processing on the objective data such as the building to be the subject, energy consumption of devices, and meteorological observation data by using a statistical method without introducing any artificial essence.

The embodiments of the present disclosure have been described above. The embodiments makes it possible to perform energy conservation diagnosis without any special knowledge of energy conservation diagnosis that is required conventionally and makes it possible to perform the diagnosis with less data items, so that a method that can be applied to a still larger number of buildings can be established.

Further, the embodiment makes it possible to extract the building with high energy saving effect from a plurality of buildings only with the information that can be acquired by the electric company, the gas company, and the like, such as the energy consumption of the building and the weather data of the meteorological station closest to the location of the building.

While examples of the preferred embodiments are presented herein, it is to be noted that the present disclosure can be achieved in content other than those described above and that the content occurred to those skilled in the art is included in the present disclosure. Further, typical examples are provided for the expression, the method, and the like, it is also to be noted that the expression and the method are not limited to those and any other formulae can be used instead.

### INDUSTRIAL APPLICABILITY

The present disclosure uses the energy consumption data of the building of each time and the weather data of the meteorological station closest to the location of the building to estimate the each-usage energy consumption of the building and to calculate the energy savable amount, the demand reducible amount, and the energy saving effect achieved by the behavior change and the like, and the calculation of the energy saving effect is systematized by using the statistical method and the like, so that energy conservation diagnosis can be achieved with high accuracy without having expert knowledge of energy conservation diagnosis.

As an industrial applicability, there may be a service capable of regularly sending detailed energy conservation diagnosis to individual buildings, and capable of checking the diagnosis result on a real-time basis via a network.

Further, the use of the present disclosure makes it possible for the gas companies, governmental organizations, and the like to take highly efficient energy saving measures by extracting the building with a room for saving energy and supporting energy saving measures.

### REFERENCE SIGNS LIST

S1 Step 1
S2 Step 2
S885 Step 885

1. An energy conservation diagnostic system for a building, comprising:
an each-usage energy consumption estimation program for performing estimation of each-usage energy consumption of the building by using energy consumption and weather data;
an energy savable amount calculation program for calculating an energy savable amount from a value calculated by the each-usage energy consumption estimation program;
an energy saving simulation program for performing energy saving simulation by using a result of at least the each-usage energy consumption estimation program out of the each-usage energy consumption estimation program and the energy savable amount calculation program; and
an output unit that outputs at least one result out of results acquired by the each-usage energy consumption estimation program, the energy savable amount calculation program, and the energy saving simulation program;
wherein the each-usage energy consumption estimation program is a program for estimating the each-usage energy consumption of the building by using the energy consumption of the building and the weather data including at least one of temperature acquired from measurement content of a meteorological station closest to location of the building or enthalpy calculated from the measurement content, the energy conservation diagnostic system comprising:
a data generation unit that re-totalizes the energy consumption data and the weather data at a specific interval to re-generate a data table classified by each measurement date/time and a data table classified by each day;
an operating day/non-operating day determination unit that classifies measurement days into operating days and non-operating days based on a relation between the energy consumption data of each day and the weather data of each day;
further, a holiday-work determination unit that determines a holiday-work date by using a method of abnormal value detection;
a regression equation calculation unit that calculates a regression equation by having the weather data of each group of a specific period of time as an independent variable and the energy consumption data as a dependent variable separately for the operating days and the non-operating days;
a baseline estimation unit that detects an abnormal value of the energy consumption from an estimate value calculated from the regression equation, and estimates a minimum value of the regression equation within a range of the weather data in the group of the specific period of time as a baseline;
a baseline correction unit that corrects the baseline of the holiday-work date; and
an each-usage energy consumption estimation unit that calculates the each-usage energy consumption from the baseline calculated by the baseline estimation unit and the energy consumption of the building.

2. (canceled)

3. The energy conservation diagnostic system according to claim 1, wherein:
the baseline correction unit configuring the each-usage energy consumption estimation program
determines whether there is a heater or a cooler from a relation between the weather data before and after the value of the weather data for which the minimum value of the regression equation was calculated and the energy consumption data,
corrects the baseline value on the holiday-work date of the non-operating days by using the estimate value calculated from the regression equation,
estimates a minimum value of the baseline as “base” where energy is used for 24 hours,
estimates a difference between the baseline and the energy consumption as “ac” that mainly includes air-conditioning consumption when there is a heater or a cooler, and
estimates a value acquired by excluding “base” and “ac” from the energy consumption as “middle” that mainly includes energy consumption of lighting; and
the output unit outputs the each-usage energy consumption, date/time on which the abnormal value is generated, and a value thereof.

4. An energy savable amount calculation program provided to the energy conservation diagnostic system according to claim 1, the energy savable amount calculation program:
assuming an energy consumption estimate value acquired from the regression equation of the each-usage energy consumption estimation system as an appropriate energy consumption;
using a statistical upper limit value and lower limit value acquired from detection of the abnormal value;
estimating a total value of differences between the energy consumption data determined as the abnormal values and the statistical upper limit value as an energy savable amount of a first step;
estimating a total of differences between the energy consumption and the appropriate energy consumption as an energy savable amount of a second step, when the energy consumption is larger than the appropriate energy consumption;
estimating a total of differences between the statistical lower limit value and the energy consumption larger than the statistical lower limit value as the energy savable amount of a third step;
calculating an energy saving rate by dividing the total of energy saving amounts by the total of the energy consumptions;
further calculating the energy consumption data, the appropriate energy consumption, the statistical upper limit value, and the statistical lower limit value by a formula for defining demand power (demand) of an electric company, and extracting respective maximum values;
estimating as a demand reducible amount of a first step when a difference between a demand power maximum value of the energy consumption data and a demand power maximum value of the statistical upper limit value is a positive value;
estimating as a demand reducible amount of a second step when a difference between the demand power maximum value of the energy consumption data and a demand power maximum value of the appropriate energy consumption is a positive value; and
estimating as a demand reducible amount of a third step when a difference between the demand power maximum value of the energy consumption data and a demand power maximum value of the statistical lower limit value is a positive value.

5. An energy saving simulation program provided to the energy conservation diagnostic system according to claim 1, the energy saving simulation program:
assuming that easing of an air-conditioning setting temperature by a specific temperature is equivalent to easing of a weather condition by a specific temperature;
generating data acquired by increasing and decreasing the weather data by a specific temperature;
substituting the data to the regression equation of the each-usage energy consumption estimation system to calculate a simulation estimate value;
using an appropriate energy consumption determined as having the heater and the cooler;
in a case where there is the heater, calculating a difference between the simulation estimate value and the appropriate energy consumption when the weather data is increased by the specific temperature;
in a case where there is the cooler, calculating a difference between the simulation estimate value and the appropriate energy consumption when the weather data is decreased by the specific temperature; and
calculating the total of the differences and an energy saving rate acquired by dividing the total of the differences by the appropriate energy consumption as an energy saving effect achieved by a behavior change and the like.

6. A calculation method of the energy savable amount, an energy savable rate, and a demand reducible amount according to claim 4, the calculation method comprising:
assuming an energy consumption estimate value acquired from the regression equation of the each-usage energy consumption estimation system as an appropriate energy consumption;
using a statistical upper limit value and lower limit value acquired from detection of the abnormal value;
estimating a total value of differences between the energy consumption data determined as the abnormal values and the statistical upper limit value as an energy savable amount of a first step;
estimating a total of differences between the energy consumption and the appropriate energy consumption as an energy savable amount of a second step, when the energy consumption is larger than the appropriate energy consumption;
estimating a total of differences between the statistical lower limit value and the energy consumption larger than the statistical lower limit value as an energy savable amount of a third step;
calculating the energy saving rate by dividing the total of energy saving amounts by the total of the energy consumptions;
further calculating the energy consumption data, the appropriate energy consumption, the statistical upper limit value, and the statistical lower limit value by a formula for defining demand power (demand) of an electric company, and extracting respective maximum values;
estimating as a demand reducible amount of a first step when a difference between a demand power maximum value of the energy consumption data and a demand power maximum value of the statistical upper limit value is a positive value;
estimating as a demand reducible amount of a second step when a difference between the demand power maximum value of the energy consumption data and a demand power maximum value of the appropriate energy consumption is a positive value; and
estimating as a demand reducible amount of a third step when a difference between the demand power maximum value of the energy consumption data and a demand power maximum value of the statistical lower limit value is a positive value.

7. A calculation method of the energy saving simulation according to claim 5, the calculation method comprising:
assuming that easing of an air-conditioning setting temperature by a specific temperature is equivalent to easing of a weather condition by a specific temperature;
generating data acquired by increasing and decreasing the weather data by a specific temperature;
substituting the data to the regression equation of the each-usage energy consumption estimation system to calculate a simulation estimate value;
using the appropriate energy consumption determined as having the heater and the cooler;
in a case where there is the heater, calculating a difference between the simulation estimate value and the appropriate energy consumption when the weather data is increased by the specific temperature;
in a case where there is the cooler, calculating a difference between the simulation estimate value and the appropriate energy consumption when the weather data is decreased by the specific temperature; and
calculating the total of the differences and an energy saving rate acquired by dividing the total of differences by the appropriate energy consumption as an energy saving effect achieved by a behavior change and the like.

8. An estimation method of the each-usage energy consumption according to claim 2, comprising:
classifying measurement days into operating days and non-operating days based on a relation between the energy consumption data and the weather data;
further determining a holiday-work date by using a method of abnormal value detection;
calculating a regression equation by having the weather data of each group of a specific period of time as an independent variable and the energy consumption data as a dependent variable separately for the operating days and the non-operating days;
detecting an abnormal value of the energy consumption by using an estimate value calculated from the regression equation;
taking a minimum value of the regression equation within a range of the weather data in the group of the specific period of time as a baseline;
determining whether there is a heater or a cooler from the relation between the weather data before and after the value of the weather data for which the minimum value of the regression equation was calculated;
correcting the baseline value on the holiday-work date of the non-operating days by using the estimate value calculated from the regression equation;
estimating a minimum value of the baseline as “base” where energy is used for 24 hours;
estimating a difference between the baseline and the energy consumption as “ac” that mainly includes air-conditioning consumption when there is the heater or the cooler; and
estimating a value acquired by excluding “base” and “ac” from the energy consumption as “middle” that mainly includes energy consumption of lighting.
